(19) United States
(12) Patent Application Publication
(10) Pub. No.: US 2019/0309137 A1
(43) Pub. Date: Oct. 10, 2019

(54) FILLED POLYURETHANE FOAM HAVING TAILORED MICROSTRUCTURES

(71) Applicants: Hamed LAKROUT, San Antonio, TX (US); Ying ZHANG, San Antonio, TX (US); Guy CROCCO, New Braunfels, TX (US); Russell HILL, San Antonio, TX (US); BORAL IP HOLDINGS (AUSTRALIA) PTY LIMITED, North Sydney (AU)

(72) Inventors: Hamed LAKROUT, San Antonio, TX (US); Ying ZHANG, San Antonio, TX (US); Guy CROCCO, New Braunfels, TX (US); Russell HILL, San Antonio, TX (US)

(73) Assignee: BORAL IP HOLDINGS (AUSTRALIA) PTY LIMITED, North Sydney (AU)

(21) Appl. No.: 16/302,066

(22) PCT Filed: May 23, 2016
(86) PCT No.: PCT/US2016/033761

§ 371 Date: Nov. 15, 2018

(51) Int. Cl. C08J 9/12; C08J 9/00; C08K 11/00

(52) U.S. Cl. CPC C08J 9/125; C08J 9/0066; C08K 11/005; C08J 2375/04; C08J 2205/046; C08J 2205/10; C08J 2203/10; C08J 2205/05

(57) ABSTRACT

Filled polyurethane foams having tailored microstructures, as well as methods of making these polyurethane foams, are described herein. By tailoring the microstructure of the polyurethane foam, composite materials having desirable mechanical properties (e.g., elastic modulus, compressive strength, or combination thereof) can be obtained.

### FIELD OF THE DISCLOSURE

This disclosure relates generally to polyurethane foams, more particularly, to highly filled polyurethane foams having tailored microstructures.

### BACKGROUND OF THE DISCLOSURE

Polymeric composites that contain organic and/or inorganic filler materials have become desirable for a variety of uses because of their excellent mechanical properties and weathering stability. In general, the superior properties of the organic-inorganic composites are achieved through use of the organic as a matrix material that acts as a glue with enhanced flexural properties or as a fibrous component providing reinforcement and improved tensile properties. The inorganic material imparts various properties of rigidity, toughness, hardness, optical appearance, interaction with electromagnetic radiation, density, and many other physical and chemical attributes.

The use of polyurethane compositions has grown due to their superior tensile strength, impact resistance, and abrasion resistance compared to, for example, unsaturated polyester and vinyl ester-based composites. Processes for preparing polyurethane foamed compositions are known and have significant commercial success. However, certain problems that often limit application of the polyurethane foams are known to those in the industry. For example, the processes to prepare these compositions may experience difficulties. Additionally, the foams may be brittle, or suffer from poor adhesion to substrates due to the relatively high urea concentration that often forms on the surface of these foams. The foams may also be dimensionally unstable, due to a relatively high diffusion coefficient of the carbon dioxide through the cell walls, and demolding may be poor due to the relatively high exothermic nature of the water-blown reactions. Thus, there is a need for alternate polyurethane foams with desirable mechanical properties. The compositions and methods described herein address these and other needs.

### SUMMARY OF THE DISCLOSURE

Filled polyurethane foams having tailored microstructures, as well as methods of making these polyurethane foams, are described herein. By tailoring the microstructure of the polyurethane foam, composite materials having desirable mechanical properties (e.g., elastic modulus, compressive strength, or combination thereof) can be obtained.

For example, provided herein are filled polyurethane foams that comprise from 50% to 90% by weight of an inorganic filler and an open cell structure having a mean trabecular separation of from 275 to 1,000 microns (e.g., from 350 to 500 microns) and a standard deviation of at least 30% of the mean trabecular separation. In these cases, the foam can have a surface to volume ratio of 90 or less (e.g., 85 or less, or from 60 to 80). In some of these embodiments, the standard deviation of the mean trabecular separation can be from 30% to 55% of the mean trabecular separation. For example, the standard deviation of the mean trabecular separation can be from 125 to 250 microns. In some of these embodiments, the open cell structure can an average trabecular thickness of at least 40 microns (e.g., from 40 to 55 microns).

Also provided herein are filled polyurethane foams that comprise from 50% to 90% by weight of an inorganic filler and an open cell structure having a mean trabecular separation of from 50 to 1,000 microns (e.g., from 350 to 500 microns) and a standard deviation of at least 40% of the mean trabecular separation. In these cases, the foam can have a surface to volume ratio of 120 or less (e.g., 90 or less, 85 or less, or from 60 to 80). In some of these embodiments, the standard deviation of the mean trabecular separation can be from 45% to 55% of the mean trabecular separation. For example, the standard deviation of the mean trabecular separation can be from 125 to 250 microns. In some of these embodiments, the open cell structure can an average trabecular thickness of at least 40 microns (e.g., from 40 to 55 microns).

In some embodiments, the foam can comprise from 60% to 85% by weight of an inorganic filler (e.g., from 65% to 80% by weight of an inorganic filler). In some cases, the inorganic filler can be a particulate inorganic filler. The inorganic filler can have a median particle size, as determined by scanning electron microscopy, of less than 500 microns (e.g., less than 20 microns, such as a median particle size of from 5 to 15 microns). In some embodiments, the inorganic filler can have a multimodal particle size distribution (e.g., a particle size distribution having at least two modes). In certain embodiments, the inorganic filler can comprise coal ash such as fly ash.

Optionally, the foam can further comprise a plurality of fibers. When present, the plurality of fibers can be present in an amount of from 0.1% to 10% by weight, based on the total weight of the foam. In some examples, the fibers can be present in an amount from 0.25% to 8%, from 0.25% to 6%, from 0.5% to 6%, or from 0.5% to 5% by weight, based on the total weight of the foam. The fibers can include, for example, glass fibers, polyalkylene fibers, polyester fibers, polyamide fibers, phenol-formaldehyde fibers, polyvinyl chloride fibers, polyacrylic fibers, acrylic polyester fibers, polyurethane fibers, polyacrylonitrile fibers, rayon fibers, cellulose fibers, carbon fibers, metal and metal-coated fibers, mineral fibers, or combinations thereof. In certain embodiments, the fibers can include a glass fibers. The fibers can have an average length of 0.1 mm or greater. In some examples, the fibers can have an average length of from 0.1 mm to 30 mm (e.g., from 1.5 mm to 30 mm). In certain embodiments, the fibers can have an average length of from 0.1 mm to 3.5 mm and/or an average diameter of from 5 to 50 microns. In some cases, the average aspect ratio of length to diameter of the fibers can be from 5:1 to 1500:1 (e.g., from 8:1 to 700:1). In certain cases, the fibers can have an average diameter equal to from 25% to 100% of the average trabecular thickness of the open cell foam.

The amount of polyurethane in the foam can be from 10% to 50% by weight, for example, 15% to 45% by weight, based on the total weight of the foam. The polyurethane can be formed from a reaction mixture comprising (i) one or more isocyanates selected from the group consisting of diisocyanates, polyisocyanates, and mixtures thereof, and (ii) one or more polyols. In some embodiments, the one or more polyols can have an average hydroxyl number of from 100 to 700 mg KOH/g, from 100 to 500 mg KOH/g., or from 200 to 400 mg KOH/g The one or more polyols can have an average molecular weight of from 250 to 1500 g/mol or from 500 to 1000 g/mol. The average functionality of the one or more polyols can be from 2.5 to 5.5, from 3 to 5.5, or from 3 to 4. The one or more polyols can have an average viscosity of 150 to 5000 cps or from 150 to 2500 cps at 25° C. In some cases, a blend of the one or more polyols and the one or more isocyanates used in the foams can have an average viscosity of from 100 to 6000 cPs, from 100 to 2500 cPs, or from 100 to 1400 cps at 25° C. In some cases, the polyurethane (and by extension the foam) can include less than 0.1% by weight surfactant, based on the total weight of the polyurethane (e.g., less than 0.05% by weight surfactant, less than 0.01% by weight surfactant, less than 0.005% by weight surfactant, or less than 0.001% by weight surfactant). In certain embodiments, the polyurethane does not include a surfactant.

The density of the foam can be at least 10 lb/ft³. In some cases, the density of the foam can be from 10 lb/ft³ to 35 lb/ft³, from 10 lb/ft³ to 30 lb/ft³, or from 15 lb/ft³ to 25 lb/ft³. The foam can exhibit an elastic modulus of 15 ksi or greater (e.g., 22 ksi or greater). For example, the foam can exhibit an elastic modulus of from 20 to 30 ksi (e.g., from 22 to 28 ksi). In some cases, the foam can exhibit a ratio of elastic modulus (in ksi) to density (in lb/ft³) of from 1:2 to 2:1. In some embodiments, the foam can exhibit a compressive strength of 150 psi or greater (e.g., 175 psi or greater, 200 psi or greater, or 220 psi or greater). For example, the foam can exhibit a compressive strength of from 200 to 250 psi (e.g., from 220 to 240 psi). In some cases, the foam can exhibit a ratio of compressive strength (in psi) to density (in lb/ft³) of from 7:1 to 25:1 (e.g., from 8:1 to 15:1).

Also provided are methods of making the polyurethane foams described herein. The methods can include mixing one or more isocyanates selected from the group consisting of diisocyanates, polyisocyanates, and mixtures thereof, one or more polyols, and an inorganic filler to form a mixture. The one or more polyols can have an average viscosity of 150 to 5000 cps or from 150 to 2500 cps at 25° C. In some cases, a blend of the one or more polyols and the one or more isocyanates used in the foams can have an average viscosity of from 100 to 6000 cPs, from 100 to 2500 cPs, or from 100 to 1400 cps at 25° C. The mixture can further comprise a catalyst (e.g., a delayed-action tin catalyst). The catalyst can be present in the mixture in an amount of from 0.05 to 0.5 parts per hundred parts of the one or more polyols. In some embodiments, the mixture can include less than 0.1% by weight surfactant, based on the total weight of the mixture (e.g., less than 0.05% by weight surfactant, less than 0.01% by weight surfactant, less than 0.005% by weight surfactant, or less than 0.001% by weight surfactant). In certain embodiments, the mixture does not include a surfactant. Methods can further include applying shear to the mixture to disperse the inorganic filler in the mixture. Optionally, mixing the one or more isocyanates, one or more polyols, and an inorganic filler can further comprise mixing a plurality of fibers to produce the mixture.

The polyurethane foam can be formed in a mold. The method can include applying the mixture to a mold at a viscosity of from 5,000 to 100,000 cps or from 20,000 to 100,000 cps at the temperature of the mixture. The mixture applied to the mold can have a tack free time of from 2 to 7 minutes. The mixture can also have a cream time of from 40 to 120 seconds or from 80 to 120 seconds.

The method of making the polyurethane foam can include allowing the mixture to react and expand. The mixture can be expanded via a gas phase provided in situ by the reaction process or physically introduced into the mixture. As discussed herein, the filler (e.g., the inorganic filler and/or fibers) may be used to control the distribution characteristics and bubble size of the gas phase in the polyurethane mixture. The gas phase can be captured after gelation of the foam. The mixture can be allowed to rise freely during foaming (e.g., in a mold). In some embodiments, the foam does not reach a hardness of 20 shore D in less than 5 minutes or in less than 10 minutes.

### DESCRIPTION OF DRAWINGS

FIG. 1 shows 3-dimensional renderings of the microstructure of polyurethane foams 1-3 obtained from micro-CT studies.

FIG. 2 shows 2-dimensional cross-sectional images of the microstructure of polyurethane foams 1-3 obtained from micro-CT studies.

FIG. 3 is a plot showing the distribution of trabecular separation in foams polyurethane 1-3.

FIG. 4 is a histogram plotting the average trabecular separation in foams 1-3.

FIG. 5 is a plot showing the distribution of trabecular thickness in foams 1-3.

FIG. 6 is a histogram plotting the average trabecular thickness in foams 1-3.

FIG. 7 is a histogram plotting the fragmentation index of foams 1-3.

FIG. 8 is a histogram plotting the foam surface to volume ratio of foams 1-3.

FIG. 9 is a histogram plotting the elastic modulus of foams 1-3.

FIG. 10 is a histogram plotting the compressive strength of foams 1-3.

### DETAILED DESCRIPTION

Filled polyurethane foams having tailored microstructures, as well as methods of making these polyurethane foams, are described herein. By tailoring the microstructure of the polyurethane foam, composite materials having desirable mechanical properties (e.g., elastic modulus, compressive strength, or combination thereof) can be obtained.

The filled polyurethane foams can comprise from 50% to 90% by weight of an inorganic filler and an open cell structure. Trabecular thickness and trabecular spacing can be used to characterize the three-dimensional (3D) structures of foams. Such 3D morphometric indices can be assessed from 3D images using direct 3D algorithms. With 3D image analysis by micro-CT a true 3D thickness can be measured which is model-independent. Local thickness for a point in solid can be defined as the diameter of the largest sphere which (1) encloses the point (without the point necessarily having to fall at the center of the sphere), and (2) is entirely bounded within solid surfaces. See, for example, Hildebrand, T and Ruegsegger, P. “A New Method for the Model Independent Assessment of Thickness in Three Dimensional Images.” J. Microsc. 1997, 185:67-75.

Local thickness measurements of this type eliminate any potential bias associated with the 3D orientation of the structure. Ulrich, D. et al. “The Ability of Three Dimensional Structural Indices to Reflect Mechanical Aspects of Trabecular Bone.” Bone, 1990, 25(1): 55-60. Distance transform methods, such as those described by Remy and Thiel, can be used as a basis for implementing local thickness measurements by means of a CT-analyzer. Remy, E. and Thiel, E. “Medial Axis for Chamfer Distances: Computing Look-Up Tables and Neighborhoods in 2D or 3D.” Pattern Recognition Letters, 2002, 23: 649-661. These methods begin with a “skeletonisation” process in which the medial axes of all structures are identified. Next, a “sphere-fitting” local thickness measurement is computed for all the voxels. A voxel represents a single sample, or data point, on a regularly spaced, three-dimensional grid. This data point can consist of a single piece of data, such as an opacity, or multiple pieces of data, such as a color in addition to opacity. A voxel represents only a single point on this grid, not a volume; the space between each voxel is not represented in a voxel-based dataset. Depending on the type of data and the intended use for the dataset, this missing information may be reconstructed and/or approximated (e.g. via interpolation). The value of a voxel may represent various properties. For example, in the case of CT scans, the values can be Hounsfield units (a quantitative measure for the radiodensity of a material). Histomorphometrists typically measure a single mean value of bone (Tb.Th) from a trabecular bone site. However a trabecular bone volume—or any complex biphasic object region—can also be characterized by a distribution of thicknesses. CT-analyzers can produce a histogram of trabecular thickness and/or trabecular separation with an interval of two pixels. Trabecular thickness distribution is a powerful method for characterizing the shape of a complex structure.

In some embodiments, the open cell structure can have a mean trabecular separation, as determined by x-ray microtomography (micro-CT), of at least 50 microns (e.g., at least 75 microns, at least 100 microns, at least 125 microns, at least 150 microns, at least 175 microns, at least 200 microns, at least 225 microns, at least 250 microns, at least 275 microns, at least 300 microns, at least 325 microns, at least 350 microns, at least 375 microns, at least 400 microns, at least 425 microns, at least 450 microns, at least 475 microns, at least 500 microns, at least 525 microns, at least 550 microns, at least 575 microns, at least 600 microns, at least 625 microns, at least 650 microns, at least 675 microns, at least 700 microns, at least 725 microns, at least 750 microns, at least 775 microns, at least 800 microns, at least 825 microns, at least 850 microns, at least 875 microns, at least 900 microns, at least 925 microns, at least 950 microns, or at least 975 microns). The open cell structure can have a mean trabecular separation, as determined by micro-CT, of 1000 microns or less (e.g., 975 microns or less, 950 microns or less, 925 microns or less, 900 microns or less, 875 microns or less, 850 microns or less, 825 microns or less, 800 microns or less, 775 microns or less, 750 microns or less, 725 microns or less, 700 microns or less, 675 microns or less, 650 microns or less, 625 microns or less, 600 microns or less, 575 microns or less, 550 microns or less, 525 microns or less, 500 microns or less, 475 microns or less, 450 microns or less, 425 microns or less, 400 microns or less, 375 microns or less, 350 microns or less, 325 microns or less, 300 microns or less, 275 microns or less, 250 microns or less, 225 microns or less, 200 microns or less, 175 microns or less, 150 microns or less, 125 microns or less, 100 microns or less, or 75 microns or less).

The open cell structure can have a mean trabecular separation, as determined by micro-CT, ranging from any of the minimum values described above to any of the maximum values described above. For example, in some embodiments, the open cell structure can have a mean trabecular separation, as determined by micro-CT, of from 50 to 1,000 microns (e.g., from 275 to 1,000 microns, or from 350 to 500 microns).

The standard deviation of the mean trabecular separation can be at least 30% of the mean trabecular separation (e.g., at least 35% of the mean trabecular separation, at least 40% of the mean trabecular separation, at least 45% of the mean trabecular separation, at least 50% of the mean trabecular separation, at least 55% of the mean trabecular separation, at least 60% of the mean trabecular separation, or at least 65% of the mean trabecular separation). The standard deviation of the mean trabecular separation can be 70% of the mean trabecular separation or less (e.g., 65% of the mean trabecular separation or less, 60% of the mean trabecular separation or less, 55% of the mean trabecular separation or less, 50% of the mean trabecular separation or less, 45% of the mean trabecular separation or less, 40% of the mean trabecular separation or less, or 35% of the mean trabecular separation or less).

The standard deviation of the mean trabecular separation can range from any of the minimum values described above to any of the maximum values described above. For example, in some embodiments, the standard deviation of the mean trabecular separation can be from 30% to 70% of the mean trabecular separation (e.g., from 30% to 55% of the mean trabecular separation, from 40% to 70% of the mean trabecular separation, or from 40% to 55% of the mean trabecular separation).

In some embodiments, the standard deviation of the mean trabecular separation can be at least 125 microns (e.g., at least 150 microns, at least 175 microns, at least 200 microns, or at least 225 microns). In some embodiments, the standard deviation of the mean trabecular separation can be 250 microns or less (e.g., 225 microns or less, 200 microns or less, 175 microns or less, or 150 microns or less).

The standard deviation of the mean trabecular separation can range from any of the minimum values described above to any of the maximum values described above. For example, in some embodiments, the standard deviation of the mean trabecular separation can be from 125 to 250 microns.

In some embodiments, the open cell structure can have a mean trabecular thickness, as determined by micro-CT, of at least 40 microns (e.g., at least 45 microns, at least 50 microns, at least 55 microns, at least 60 microns, at least 65 microns, at least 70 microns, at least 75 microns, at least 80 microns, at least 85 microns, at least 90 microns, or at least 95 microns).

The open cell structure can have a mean trabecular thickness, as determined by micro-CT, of 100 microns or less (e.g., 95 microns or less, 90 microns or less, 85 microns or less, 80 microns or less, 75 microns or less, 70 microns or less, 65 microns or less, 60 microns or less, 55 microns or less, 50 microns or less, or 45 microns or less).

The open cell structure can have a mean trabecular thickness, as determined by micro-CT, ranging from any of the minimum values described above to any of the maximum values described above. For example, in some embodiments, the open cell structure can have a mean trabecular thickness, as determined by micro-CT, of from 40 to 100 microns (e.g., from 40 to 75 microns, from 40 to 65 microns, or from 40 to 55 microns).

The microstructure of the foams described herein can also be characterized in terms of surface area and surface to volume ratio. Total volume of the volume-of-interest (VOI) is the 3D volume measurement based on the marching cubes volume model of the VOI. See, for example, Lorensen, W. E. and Cline, H. E. “Marching Cubes: A High Resolution 3D Surface Construction Algorithm.” Computer Graphics, 1987, 21(4): 163-169. The foam surface is the surface area of all the solid objects within the volume of interest, measured in 3D using the marching cubes method. The foam surface to volume ratio is the ratio of these two measurements.

In some embodiments, the foam can have a surface to volume ratio, as determined by micro-CT, of 90 or less (e.g., 85 or less, 80 or less, 75 or less, 70 or less, 65 or less, 60 or less, or 55 or less). The foam can have a surface to volume ratio, as determined by micro-CT, of at least 50 (e.g., at least 55, at least 60, at least 65, at least 70, at least 75, at least 80, or at least 85)

The foam can have a surface to volume ratio, as determined by micro-CT, ranging from any of the minimum values described above to any of the maximum values described above. For example, in some embodiments, the foam can have a surface to volume ratio, as determined by micro-CT, of from 50 to 90 (e.g., from 60 to 90, or from 60 to 80).

Foams can also be characterized by their fragmentation index. The trabecular fragmentation index is an inverse index of connectivity measured in inverse millimeters. Hahn, M. et al. “Trabecular Bone Pattern Factor—A New Parameter for Simple Quantification of Bone Microarchitecture.” Bone, 1992, 13: 327-330. Originally applied to 2D images of trabecular bone, the trabecular fragmentation index is a measure of the relative convexity or concavity of a microstructures surface. Concavity indicates connectivity (and the presence of “nodes”), while convexity indicates isolated disconnected structures (struts). The fragmentation index can be calculated in 3D by comparing volume and surface of a binarised solid before and after single voxel image dilation. The fragmentation index is defined as (S₁−S₂)/(V₁−V₂), where S and V are solid surface and volume respectively, and the subscript numbers 1 and 2 refer to measures made before and after image dilation respectively. Where foam connectedness results in enclosed spaces, dilation of foam surfaces will contract the surface. By contrast, open ends or nodes will have their surface expanded by surface dilation. As a result, lower fragmentation indices signify better connected strut lattices, while higher trabecular fragmentation indices suggest a more disconnected foam structure. A prevalence of enclosed cavities and concave surfaces can push the fragmentation index towards negative values. In certain embodiments, the foams described herein can exhibit a negative fragmentation index.

The polyurethane foam can comprise a polyurethane formed using reactive systems including isocyanates and polyols. Isocyanates suitable for use in the foam described herein include one or more monomeric or oligomeric poly- or di-isocyanates. The monomeric or oligomeric poly- or di-isocyanate include aromatic diisocyanates and polyisocyanates. The isocyanates can also be blocked isocyanates or pre-polymer isocyanates. The particular isocyanate used in the foam can be selected based on the desired viscosity of the mixture used to form the foam. An initial low viscosity is desirable for ease of handling. Other factors that influence the particular isocyanate can include the overall properties of the foam, such as the amount of foaming, strength of bonding to the inorganic filler, wetting of the inorganic particulates in the reaction mixture, strength of the resulting foam, stiffness (elastic modulus), and reactivity. Suitable isocyanate compositions for forming the foam include those having viscosities ranging from 25 to 700 cps at 25° C.

An example of a useful diisocyanate is methylene diphenyl diisocyanate (MDI). Useful MDI's include MDI monomers, MDI oligomers, and mixtures thereof. Further examples of useful isocyanates include those having NCO (i.e., the reactive group of an isocyanate) contents ranging from about 25% to about 35% by weight. Examples of useful isocyanates are found, for example, in Polyurethane Handbook: Chemistry, Raw Materials, Processing Application, Properties, 2^{nd} Edition, Ed: Gunter Oertel; Hanser/Gardner Publications, Inc., Cincinnati, Ohio, which is herein incorporated by reference. Suitable examples of aromatic polyisocyanates include 2,4- or 2,6-toluene diisocyanate, including mixtures thereof; p-phenylene diisocyanate; tetramethylene and hexamethylene diisocyanates; 4,4-dicyclohexylmethane diisocyanate; isophorone diisocyanate; 4,4-phenylmethane diisocyanate; polymethylene polyphenylisocyanate; and mixtures thereof. In addition, triisocyanates may be used, for example, 4,4,4-triphenylmethane triisocyanate; 1,2,4-benzene triisocyanate; polymethylene polyphenyl polyisocyanate; methylene polyphenyl polyisocyanate; and mixtures thereof. Suitable blocked isocyanates are formed by the treatment of the isocyanates described herein with a blocking agent (e.g., diethyl malonate, 3,5-dimethylpyrazole, methylethylketoxime, and caprolactam). Isocyanates are commercially available, for example, from Bayer Corporation (Pittsburgh, Pa.) under the trademarks MONDUR and DESMODUR. Other examples of suitable isocyanates include MONDUR MR Light (Bayer Corporation; Pittsburgh, Pa.), PAPI 27 (Dow Chemical Company; Midland, Mich.), Lupranate M20 (BASF Corporation; Florham Park, N.J.), Lupranate M70L (BASF Corporation; Florham Park, N.J.), Rubinate M (Huntsman Polyurethanes; Geismar, La.), Econate 31 (Ecopur Industries), and derivatives thereof.

The average functionality of isocyanates useful with the foams described herein can be from 1.5 to 5. Further, examples of useful isocyanates include isocyanates with an average functionality of 2 to 4.5, 2.2 to 4, 2.4 to 3.7, 2.6 to 3.4, and 2.8 to 3.2.

As indicated herein, the polyurethane foam includes one or more polyols. It is generally desirable to use polyols in liquid form, and generally in low viscosity liquid form available, as these can be more easily mixed. Suitable polyol compositions for forming the polyurethane foam include those having viscosities of 5000 cps or less at 25° C. In certain embodiments, the polyol composition can include those having viscosities of 4500 cps or less, 4000 cps or less, 3500 cps or less, 3000 cps or less, 2500 cps or less, or 2000 cps or less at 25° C. In certain embodiments, the polyol composition can include those having viscosities of 150 cps or greater, 250 cps or greater, 500 cps or greater, 750 cps or greater, 1000 cps or greater, or 1500 cps or greater. In certain embodiments, the polyol composition can include those having viscosities of from 150 to 5000 cps or from 150 to 2500 cps at 25° C. In some embodiments, a blend of the one or more polyols and the one or more isocyanates used in the foams can have a viscosity of from 100 to 6000 cPs, from 100 to 2500 cPs, from 100 to 1400 cps, from 100 to 1200 cps, or from 100 to 1000 cps at 25° C.

The one or more polyols for use in the polyurethane can include polyester polyols, polyether polyols, Mannich polyols, or combinations thereof. The choice and amounts of polyol, especially the number of reactive hydroxyl groups per polyol, the functionality, and the size and flexibility of its molecular structure, may control the mechanical and physical properties of the foam formed.

The one or more polyols can have an average equivalent weight of 150 g/eq or greater (e.g., 175 g/eq or greater, 200 g/eq or greater, 210 g/eq or greater, 220 g/eq or greater, 225 g/eq or greater, or 230 g/eq or greater). In some cases, the one or more polyols have an average equivalent weight of 700 g/eq or less (e.g., 550 g/eq or less, 500 g/eq or less, 450 g/eq or less, 400 g/eq or less, 350 g/eq or less, 300 g/eq or less, 275 g/eq or less, 250 g/eq or less, or 235 g/eq or less). In some cases, the one or more polyols have an average equivalent weight of from 150 g/eq to 700 g/eq, from 175 g/eq to 700 g/eq, from 200 g/eq to 700 g/eq, from 150 g/eq to 500 g/eq, from 150 g/eq to 400 g/eq, or from 150 g/eq to 300 g/eq. In some embodiments, the one or more polyols do not include any polyols having an equivalent weight of 750 g/eq or greater.

In some embodiments, the one or more polyols in the polyurethane or polyisocyanurate foam stock can include a less reactive polyol. The less reactive polyol can have lower numbers of primary hydroxyl groups, lower primary hydroxyl numbers, higher numbers of secondary hydroxyl groups, and higher cream times and tack-free times in a polyurethane or polyisocyanurate mixture, than a highly reactive polyol. In some embodiments, the one or more polyols can be capped with an alkylene oxide group, such as ethylene oxide, propylene oxide, butylene oxide, and combinations thereof, to provide the polyols with the desired reactivity. In some examples, the one or more polyols can include a poly(propylene oxide) polyol which contain terminal secondary hydroxyl groups and are end-capped with ethylene oxide to provide polyols with primary hydroxyl groups.

In some embodiments, the one or more polyols have about 40% or less primary hydroxyl groups, about 35% or less primary hydroxyl groups, about 30% or less primary hydroxyl groups, about 25% or less primary hydroxyl groups, about 20% or less primary hydroxyl groups, about 15% or less primary hydroxyl groups, or even about 10% or less primary hydroxyl groups. The one or more polyols can have primary hydroxyl numbers (as measured in units of mg KOH/g) of less than about 220, less than about 200, less than about 180, less than about 160, less than about 140, less than about 120, less than about 100, less than about 80, less than about 60, less than about 40, or even less than about 20. The number of primary hydroxyl groups can be determined using fluorine NMR spectroscopy as described in ASTM D4273.

The one or more polyols can have hydroxyl numbers (as measured in units of mg KOH/g) of 1000 or less, 900 or less, 800 or less, 700 or less, 650 or less, 600 or less, 550 or less, 500 or less, 450 or less, 400 or less, 350 or less, 300 or less, 250 or less, 200 or less, or 150 or less. The one or more polyols can have hydroxyl numbers (as measured in units of mg KOH/g) of 50 or more, 100 or more, 150 or more, 200 or more, 250 or more, 300 or more, 350 or more, 400 or more, 450 or more, or 500 or more. In some embodiments, the average hydroxyl number is 700 or less, 650 or less, 600 or less, 550 or less, 500 or less, 450 or less, 400 or less, 350 or less, 300 or less, or 250 or less, and/or is 100 or more, 150 or more, 200 or more, 250 or more, 300 or more, 350 or more, 400 or more, 450 or more, or 500 or more. For example, the average hydroxyl number can be from 100-700, 100-500, 150-450, or 200-400. In some embodiments, the one or more polyols include two or more polyols. For example, there can be a blend of 75% of a polyol having a hydroxyl number of 400 and 25% of a polyol having a hydroxyl number of 100 to produce an average hydroxyl number of 325.

The polyurethane or polyisocyanurate foam stock can include one or more polyols that can provide a delay in the cream time and tack free time of the polyurethane or polyisocyanurate mixture during foaming. For example, the foam stock can include polyols containing glycerine and/or amine groups which can delay the cream time and/or tack free time of the polyurethane or polyisocyanurate mixture. In some embodiments, the one or more polyols can increase the cream time of the polyurethane or polyisocyanurate mixture to 40 seconds or greater such as from 40 seconds to 120 seconds. In some embodiments, the one or more polyols can increase the tack-free time of the polyurethane or polyisocyanurate mixture to 90 seconds or greater such as from 90 seconds to 7 minutes.

The one or more polyols can include amine groups, such as primary amine groups, secondary amine groups, tertiary amine groups, or combinations thereof. In some embodiments, the total amine value (i.e., a measure of the concentration of tertiary, secondary, and primary amine groups as measured in units of mg KOH/g) is 50 or less, 45 or less, 40 or less, 35 or less, 30 or less, 25 or less, 20 or less, 15 or less, 10 or less, or 5 or less. The one or more polyols can have a total amine value (as measured in units of mg KOH/g) of from 0 to 50, from greater than 0 to 50, or from greater than 0 to 45.

The functionality of the one or more polyols useful with the foam described herein can be 7 or less, 6.5 or less, 6 or less, 5.5 or less, 5 or less, 4.5 or less, 4 or less, 3.5 or less, 3.25 or less, 3 or less, 2.75 or less, 2.5 or less, or 2.25 or less. In some embodiments, the functionality of the one or more polyols can be 2 or greater, 2.25 or greater, 2.5 or greater, 2.75 or greater, 3 or greater, 3.25 or greater, 3.5 or greater, 3.75 or greater, or 4 or greater. The average functionality of the one or more polyols useful with the foam described herein can be 5.5 or less, for example, 5 or less, 4.5 or less, 4 or less, 3.5 or less, 3.25 or less, 3 or less, 2.75 or less, 2.5 or less, or 2.25 or less. In some embodiments, the average functionality of the one or more polyols can be 2 or greater, 2.25 or greater, 2.5 or greater, 2.75 or greater, 3 or greater, 3.25 or greater, 3.5 or greater, 3.75 or greater, or 4 or greater. Further, examples of useful first polyols include polyols with an average functionality of from 2.5 to 5.5, from 3 to 5.5, from 3 to 5, from 3 to 4.5, from 2.5 to 4, from 2.5 to 3.5, or from 3 to 4.

The one or more polyols can have an average molecular weight of 250 g/mol or greater (e.g., 300 g/mol or greater, 350 g/mol or greater, 400 g/mol or greater, 450 g/mol or greater, 500 g/mol or greater, 550 g/mol or greater, 600 g/mol or greater, 650 g/mol or greater, 700 g/mol or greater, 750 g/mol or greater, 800 g/mol or greater, 900 g/mol or greater, 1000 g/mol or greater, 1200 g/mol or greater, or 1400 g/mol or greater). In some cases, the one or more polyols have an average molecular weight of 1500 g/mol or less (e.g., 1400 g/mol or less, 1300 g/mol or less, 1200 g/mol or less, 1100 g/mol or less, 1000 g/mol or less, 900 g/mol or less, 800 g/mol or less, 750 g/mol or less, 700 g/mol or less, 650 g/mol or less, 600 g/mol or less, 550 g/mol or less, 500 g/mol or less, 450 g/mol or less, 400 g/mol or less, or 300 g/mol or less). In some cases, the one or more polyols have an average molecular weight of from 250 g/mol to 1500 g/mol, from 250 g/mol to 1000 g/mol, or from 500 g/mol to 1000 g/mol. In some embodiments, the one or more polyols do not include any polyols having a molecular weight of 1000 g/mol or greater.

The one or more polyols can include polyester polyols, polyether polyols, or combinations thereof. Suitable polyols include polyether polyols such as those sold under the Carpol® trademark or under the Jeffol® trademark. In some examples, the polyether polyol can include a glycerin-based polyol and derivatives thereof commercially available from Carpenter Co. (e.g., Carpol® GP-240; Carpol® GP-725; Carpol® GP-700; Carpol® GP-1000; Carpol® GP-1500;). In some examples, the polyether polyol can include a polypropylene-based polyol and derivatives thereof commercially available from Huntsman International (e.g., Jeffol® FX31-240; Jeffol® G30-650; Jeffol® FX31-167; Jeffol® A-630; Jeffol® AD-310). Suitable polyols include polyester polyols available from Huntsman International (e.g., XO 13001). In some embodiments, the polyols can include a sucrose and/or amine-based polyol. The sucrose and/or amine-based polyol can include, for example, a polyether polyol (including for example ethylene oxide, propylene oxide, butylene oxide, and combinations thereof) which is initiated by a sucrose and/or amine group. Sucrose and/or amine-based polyols are known in the art, and include, for example, sucrose/amine initiated polyether polyol sold under the trade name CARPOL® SPA-357 or CARPOL® SPA-530 (Carpenter Co., Richmond, Va.) and triethanol amine initiated polyether polyol sold under the trade name CARPOL® TEAP-265 (Carpenter Co., Richmond, Va.).

The polyurethane or polyisocyanurate foam stock can include one or more additional polyols. In some examples, the one or more additional polyols include aromatic polyols such as aromatic polyester polyols, aromatic polyether polyols, or combinations thereof, such as those sold under the TEROL® trademark (e.g., TEROL® 198 and TEROL® 250). The aromatic polyol can have an aromaticity of 35% or greater, such as 38% or greater, 40% or greater, 45% or greater, 50% or greater, or 55% or greater and/or an aromaticity of 80% or less, 75% or less, 70% or less, 65% or less, 60% or less, 55% or less, 50% or less, 45% or less, 50% or less, 45% or less, or 40% or less.

In some embodiments, the one or more additional polyols can include polyols having a large number of primary hydroxyl groups (e.g. 75% or more) based on the total number of hydroxyl groups in the polyol. For example, the high primary hydroxyl group polyols can include 80% or more, 85% or more, 90% or more, 95% or more, or 100% of primary hydroxyl groups.

In some embodiments, the one or more additional polyols can include a Mannich polyol. Mannich polyols are the condensation product of a substituted or unsubstituted phenol, an alkanolamine, and formaldehyde. Mannich polyols can be prepared using methods known in the art. For example, Mannich polyols can be prepared by premixing the phenolic compound with a desired amount of the alkanolamine, and then slowly adding formaldehyde to the mixture at a temperature below the temperature of Novolak formation. At the end of the reaction, water is stripped from the reaction mixture to provide a Mannich base. See, for example, U.S. Pat. No. 4,883,826, which is incorporated herein by reference in its entirety. The Mannich base can then be alkoxylated to provide a Mannich polyol.

The substituted or unsubstituted phenol can include one or more phenolic hydroxyl groups. In certain embodiments, the substituted or unsubstituted phenol includes a single hydroxyl group bound to a carbon in an aromatic ring. The phenol can be substituted with substituents which do not undesirably react under the conditions of the Mannich condensation reaction, a subsequent alkoxylation reaction (if performed), or the preparation of polyurethanes from the final product. Examples of suitable substituents include alkyl (e.g., a C₁-C₁₈ alkyl, or a C₁-C₁₂ alkyl), aryl, alkoxy, phenoxy, halogen, and nitro groups.

Examples of suitable substituted or unsubstituted phenols that can be used to form Mannich polyols include phenol, o-, p-, or m-cresols, ethylphenol, nonylphenol, dodecylphenol, p-phenylphenol, various bisphenols including 2,2-bis(4-hydroxyphenyl)propane (bisphenol A), β-naphthol, β-hydroxyanthracene, p-chlorophenol, o-bromophenol, 2,6-dichlorophenol, p-nitrophenol, 4- or 2-nitro-6-phenylphenol, 2-nitro-6- or 4-methylphenol, 3,5-dimethylphenol, p-isopropylphenol, 2-bromo-6-cyclohexylphenol, and combinations thereof. In some embodiments, the Mannich polyol is derived from phenol or a monoalkyl phenols (e.g., a para-alkyl phenols). In some embodiments, the Mannich polyol is derived from a substituted or unsubstituted phenol selected from the group consisting of phenol, para-n-nonylphenol, and combinations thereof.

The alkanolamine used to produce the Mannich polyol can include a monoalkanolamine, a dialkanolamine, a trialkanolamine, a tetraalkanolamine, or combinations thereof. Examples of suitable monoalkanolamines include methylethanolamine, ethylethanolamine, methylisopropanolamine, ethylisopropanolamine, methyl-2-hydroxybutylamine, phenylethanolamine, ethanolamine, isopropanolamine, and combinations thereof. Suitable dialkanolamines include dialkanolamines which include two hydroxy-substituted C₁-C₁₂ alkyl groups (e.g., two hydroxy-substituted C₁-C₈ alkyl groups, or two hydroxy-substituted C₁-C₆ alkyl groups). The two hydroxy-substituted alkyl groups can be branched or linear, and can be of identical or different chemical composition. Examples of suitable dialkanolamines include diethanolamine, diisopropanolamine, ethanolisopropanolamine, ethanol-2-hydroxybutylamine, isopropanol-2-hydroxybutylamine, isopropanol-2-hydroxyhexylamine, ethanol-2-hydroxyhexylamine, and combinations thereof. Suitable trialkanolamines include trialkanolamines which include three hydroxy-substituted C₁-C₁₂ alkyl groups (e.g., three hydroxy-substituted C₁-C₈ alkyl groups, or three hydroxy-substituted C₁-C₆ alkyl groups). The three hydroxy-substituted alkyl groups can be branched or linear, and can be of identical or different chemical composition. Examples of suitable trialkanolamines include triisopropanolamine (TIPA), triethanolamine, N,N-bis(2-hydroxyethyl)-N-(2-hydroxypropyl)amine (DEIPA), N,N-bis(2-hydroxypropyl)-N-(hydroxyethyl)amine (EDIPA), tris(2-hydroxybutyl)amine, hydroxyethyl di(hydroxypropyl)amine, hydroxypropyl di(hydroxyethyl)amine, tri(hydroxypropyl)amine, hydroxyethyl di(hydroxy-n-butyl)amine, hydroxybutyl di(hydroxypropyl)amine, and combinations thereof. Exemplary tetraalkanolamines include four hydroxy-substituted C₁-C₁₂ alkyl groups (e.g., four hydroxy-substituted C₁-C₈ alkyl groups, or four hydroxy-substituted C₁-C₆ alkyl groups). In certain embodiments, the alkanolamine is selected from the group consisting of diethanolamine, diisopropanolamine, and combinations thereof.

Any suitable alkylene oxide or combination of alkylene oxides can be used to form the Mannich polyol. In some embodiments, the alkylene oxide is selected from the group consisting of ethylene oxide, propylene oxide, butylene oxide, and combinations thereof. In certain embodiments, the Mannich polyol is alkoxylated with from 100% to about 80% propylene oxide and from 0 to about 20 wt % ethylene oxide.

Mannich polyols are known in the art, and include, for example, ethylene and propylene oxide-capped Mannich polyols sold under the trade names CARPOL® MX-425 and CARPOL® MX-470 (Carpenter Co., Richmond, Va.).

In some embodiments, the reaction mixture can include one or more additional isocyanate-reactive monomers such as one or more polyamines. Suitable polyamines can correspond to the polyols described herein (for example, a polyester polyol or a polyether polyol), with the exception that the terminal hydroxy groups are converted to amino groups, for example by amination or by reacting the hydroxy groups with a diisocyanate and subsequently hydrolyzing the terminal isocyanate group to an amino group. By way of example, the polyamine can be polyether polyamine, such as polyoxyalkylene diamine or polyoxyalkylene triamine. Polyether polyamines are known in the art, and can be prepared by methods including those described in U.S. Pat. No. 3,236,895 to Lee and Winfrey. Exemplary polyoxyalkylene diamines are commercially available, for example, from Huntsman Corporation under the trade names Jeffamine® D-230, Jeffamine® D-400 and Jeffamine® D-2000. Exemplary polyoxyalkylene triamines are commercially available, for example, from Huntsman Corporation under the trade names Jeffamine® T-403, Jeffamine® T-3000, and Jeffamine® T-5000.

In some embodiments, the reaction mixture can include an alkoxylated polyamine (i.e., alkylene oxide-capped polyamines) derived from a polyamine and an alkylene oxide. Alkoxylated polyamines can be formed by reacting a suitable polyamine with a desired number of moles of an alkylene oxide. Suitable polyamines include monomeric, oligomeric, and polymeric polyamines. In some cases, the polyamines has a molecular weight of less than 1000 g/mol (e.g., less than 800 g/mol, less than 750 g/mol, less than 500 g/mol, less than 250 g/mol, or less than 200 less than 200 g/mol). Examples of suitable polyamines that can be used to form alkoxylated polyamines include ethylenediamine, 1,3-diaminopropane, putrescine, cadaverine, hexamethylenediamine, 1,2-diaminopropane, o-phenylenediamine, m-phenylenediamine, p-phenylenediamine, spermidine, spermine, norspermidine, toluene diamine, 1,2-propane-diamine, diethylenetriamine, triethylenetetramine, tetraethylene-pentamine (TEPA), pentaethylenehexamine (PEHA), and combinations thereof. Any suitable alkylene oxide or combination of alkylene oxides can be used to cap the polyamine. In some embodiments, the alkylene oxide is selected from the group consisting of ethylene oxide, propylene oxide, butylene oxide, and combinations thereof. Alkylene oxide-capped polyamines are known in the art, and include, for example, propylene oxide-capped ethylene diamine sold under the trade name CARPOL® EDAP-770 (Carpenter Co., Richmond, Va.) and ethylene and propylene oxide-capped ethylene diamine sold under the trade name CARPOL® EDAP-800 (Carpenter Co., Richmond, Va.).

The additional isocyanate-reactive monomer (when used) can be present in varying amounts relative the one or more polyols used to form the polyurethane. In some embodiments, the additional isocyanate-reactive monomer can be present in an amount of 30% or less, 25% or less, 20% or less, 15% or less, 10% or less, or 5% or less by weight based on the weight of the one or more polyols.

As indicated herein, in the polyurethane foams, one or more isocyanates are reacted with the one or more polyols (and any additional isocyanate-reactive monomers) to produce the polyurethane formulation. In general, the ratio of isocyanate groups to the total isocyanate reactive groups, such as hydroxyl groups, water and amine groups, is in the range of about 0.5:1 to about 1.5:1, which when multiplied by 100 produces an isocyanate index between 50 and 150. Additionally, the isocyanate index can be from about 80 to about 120, from about 90 to about 120, from about 100 to about 115, or from about 105 to about 110. As used herein, an isocyanate may be selected to provide a reduced isocyanate index, which can be reduced without compromising the chemical or mechanical properties of the foam.

One or more catalysts can be added to facilitate curing and can be used to control the curing time of the polyurethane matrix. Examples of useful catalysts include amine-containing catalysts (such as DABCO, tetramethylbutanediamine, and diethanolamine) and tin-, mercury-, and bismuth-containing catalysts. In some embodiments, the catalyst includes a delayed-action tin catalyst. In some embodiments, 0.01 wt % to 2 wt % catalyst or catalyst system (e.g., 0.025 wt % to 1 wt %, 0.05 wt % to 0.5 wt %, or 0.1 wt % to about 0.25 wt %) can be used based on the weight of the polyurethane. In some embodiments, 0.05 to 0.5 parts catalyst or catalyst system per hundred parts of polyol can be used.

Surfactants have traditionally been used in polyurethane foams to perform several functions. Specifically, surfactants lower surface tension, emulsify incompatible formulation ingredients, promote nucleation of bubbles during mixing, stabilize the rising foam by reducing stress concentrations in thinning cell-walls, and counteract the defoaming effect of any solids added to or formed. By doing this, the surfactant prevents the coalescence of rapidly growing cells until those cells have attained sufficient strength through polymerization to become self-supporting. Without this effect, continuing cell coalescence would lead to total foam collapse or a cell structure with large cell size and an uncontrollable distribution.

In prior art formulations, the uniform and coherent distribution of bubbles throughout the matrix is possible by the addition of surfactants that control the bubble size and distribution by controlling the interfacial energy and surface tension of the gas phase and the rapidly hardening fluid phase of the polyurethane. In some cases, the polyurethane foams described herein are made with little or no surfactant. For example, in some cases, the polyurethane (and by extension the foam) can include less than 0.1% by weight surfactant, based on the total weight of the polyurethane (e.g., less than 0.05% by weight surfactant, less than 0.01% by weight surfactant, less than 0.005% by weight surfactant, or less than 0.001% by weight surfactant). In certain embodiments, the polyurethane does not include a surfactant. In other embodiments, the polyurethane (and by extension the foam) can include 0.1% by weight or more surfactant, based on the total weight of the polyurethane. In some of these embodiments, the surfactant can be, for example, a surfactant that exhibits relatively poor compatibility with the components of the polyurethane. In some of these embodiments, the polyurethane can further include an agent that counteracts the effect of the surfactant (e.g., a defoamer and/or a cell opener).

Without wishing to be bound by theory, it is believed that the inorganic filler and/or fibers can control the microstructure of the polyurethane foams provided in the present disclosure in the absence of a surfactant. In particular, the polyurethane foams described herein form a gel when the one or more polyols react with the one or more isocyanates during polymerization. The polymerization and gelation process may result in an increase in viscosity (when measured in centipoise) of at least five or more orders of magnitude, through a rapid process lasting several seconds to a few minutes. When a blowing agent, for example carbon dioxide produced in-situ or a physical blowing agent such as pentafluorocarbon-propane, is present in a suitable amount, there can be simultaneous production of fine to coarse bubbles of the gas phase dispersed in the rapidly gelling polyurethane matrix. The addition of one or more catalysts can further control the rate of the gelation and the rate of the blowing reaction. It is believed that the bubble size and the bubble distribution in the polyurethane can be controlled through the control of the viscosity change during the gelation reaction and the presence of fillers and/or fiber. In particular, the presence of inorganic fillers and/or fibers in the gelling polyurethane can result in a higher starting viscosity of the mixture compared to polyurethane made without fillers and/or fibers. The higher starting viscosity of the filled polyurethane mixture may allow for a preferred capture of the gas phase during the gelation process. The fillers and/or fibers present in the rapidly hardening polyurethane mixture may disrupt the gas phase and can prevent their coalescence into large bubbles. A uniform distribution of the filler and/or fibers through external shear can permit a uniform distribution of the gas phase. Additionally, the filled polyurethane matrix can restrict migration of the bubbles which allows for a uniform distribution of the bubbles without the need for a surfactant. It is also believed that the size of the bubbles can be controlled by the dimensions (including diameter and length) of the filler and/or fibers.

The polyurethane can be present in the foam in amounts from 10% to 50% based on the weight of the foam. For example, the polyurethane can be included in an amount from 14% to 50% or 20% to 50% by weight, based on the weight of the foam. In some embodiments, the polyurethane can be present in an amount of 10% or greater, 15% or greater, 20% or greater, 25% or greater, 30% or greater, 35% or greater, 40% or greater, or 45% or greater by weight, based on the weight of the foam. In some embodiments, the polyurethane can be present in an amount of 50% or less, 45% or less, 40% or less, 35% or less, 30% or less, 25% or less, 20% or less, or 15% or less by weight, based on the weight of foam.

As described herein, the polyurethane foam includes an inorganic filler. The inorganic filler can be a particulate inorganic filler. Suitable examples of fillers include ash, ground/recycled glass (e.g., window or bottle glass); milled glass; glass spheres; glass flakes; activated carbon; calcium carbonate; aluminum trihydrate (ATH); silica; sand; ground sand; silica fume; slate dust; crusher fines; red mud; amorphous carbon (e.g., carbon black); clays (e.g., kaolin); mica; talc; wollastonite; alumina; feldspar; bentonite; quartz; garnet; saponite; beidellite; granite; slag; calcium oxide; calcium hydroxide; antimony trioxide; barium sulfate; magnesium oxide; titanium dioxide; zinc carbonate; zinc oxide; nepheline syenite; perlite; diatomite; pyrophillite; flue gas desulfurization (FGD) material; soda ash; trona; expanded clay; expanded shale; expanded perlite; vermiculite; volcanic tuff; pumice; hollow ceramic spheres; hollow plastic spheres; expanded plastic beads (e.g., polystyrene beads); ground tire rubber; and mixtures thereof.

The inorganic filler can have a median particle size, as determined by scanning electron microscopy, of from 0.2 micron to 500 microns. For example, the inorganic filler can have a median particle size of 500 microns or less (e.g., 450 microns or less, 400 microns or less, 350 microns or less, 300 microns or less, 250 microns or less, 200 microns or less, 150 microns or less, 100 microns or less, 95 microns or less, 90 microns or less, 85 microns or less, 80 microns or less, 75 microns or less, 70 microns or less, 65 microns or less, 60 microns or less, 55 microns or less, 50 microns or less, 45 microns or less, 40 microns or less, 35 microns or less, 30 microns or less, 25 microns or less, 20 microns or less, 15 microns or less, 10 microns or less, 5 microns or less, 2 microns or less, or 1 micron or less). In some embodiments, the inorganic filler can have a median particle size of 0.2 microns or more (e.g., 0.3 microns or more, 0.4 microns or more, 0.5 microns or more, 0.7 microns or more, 1 micron or more, 2 microns or more, 5 microns or more, 10 microns or more, 15 microns or more, 20 microns or more, 25 microns or more, 30 microns or more, 35 microns or more, 40 microns or more, 45 microns or more, 50 microns or more, 55 microns or more, 60 microns or more, 65 microns or more, 70 microns or more, 75 microns or more, 80 microns or more, 85 microns or more, 90 microns or more, 95 microns or more, 100 microns or more, 150 microns or more, 200 microns or more, 250 microns or more, 300 microns or more, 350 microns or more, 400 microns or more, or 450 microns or more).

The inorganic filler can have a median particle size ranging from any of the minimum values described above to any of the maximum values described above. For example, the inorganic filler can have a median particle size of from 0.2 microns to 500 microns (e.g., from 0.2 microns to 90 microns, from 0.3 microns to 80 microns, from 1 micron to 50 microns, from 1 micron to 25 microns, from 1 micron to 20 microns, from 5 microns to 20 microns, or from 5 microns to 15 microns.

In some embodiments, the inorganic filler includes an ash. The ash can be a coal ash or another type of ash such as those produced by firing fuels including industrial gases, petroleum coke, petroleum products, municipal solid waste, paper sludge, wood, sawdust, refuse derived fuels, switchgrass or other biomass material. The coal ash can be fly ash, bottom ash, or combinations thereof. In some examples, the particulate filler includes fly ash. Fly ash is produced from the combustion of pulverized coal in electrical power generating plants. The fly ash useful with the foam described herein can be Class C fly ash, Class F fly ash, or a mixture thereof. Fly ash produced by coal-fueled power plants is suitable for incorporation in the foam described herein. In some embodiments, the inorganic filler consists of or consists essentially of fly ash.

The fly ash can have a particle size distribution with at least two modes. For example, the particle size distribution of the fly ash can be three, four, five, or more modes. Alternatively, the fly ash can be blended with another fly ash to modify the properties of the fly ash to produce a fly ash having a particle size distribution with at least three modes.

In some embodiments, the fly ash can include a first mode having a median particle diameter of 2.0 microns or less. In some examples, the median particle size of the first mode can be 0.3 microns to 1.5 microns, 0.4 microns to 1 microns, or 0.5 microns to 0.8 microns (e.g., 0.7 microns). The fly ash can include a second mode having a median particle diameter of from 3 microns to less than 40 microns. In some examples, the median particle size of the second mode can be from 5 microns to 35 microns, 10 microns to 30 microns, or 10 microns to 25 microns. The fly ash can include a third mode having a median particle diameter of 40 microns or greater. In some examples, the median particle size of the third mode can be from 40 microns to less than 100 microns, for example from 40 microns to 90 microns, 40 microns to 80 microns, or from 40 microns to 75 microns. In some embodiments, the fly ash can include a first mode having a median particle diameter of from 0.3 microns to 1.0 micron, a second mode having a median particle diameter of from 10 microns to 25 microns, and a third mode having a median particle diameter of from 40 microns to 80 microns. In some examples, the fly ash can also include an additional ultrafine mode with a median particle diameter of from 0.05 microns to 0.2 microns.

In some embodiments, the particle size distribution can include 11-35% of the particles by volume in the first mode, 65-89% of the particles by volume in the second mode. In some embodiments, the particle size distribution can include 11-17% of the particles by volume in the first mode, 56-74% of the particles by volume in the second mode, and 12-31% of the particles by volume in the third mode. The ratio of the volume of particles in the second mode to the volume of particles in the first mode can be from 4.5 to 7.5.

The inorganic filler can be present in the foam described herein in amounts from 35% to 90% by weight. Examples of the amount of inorganic filler present in the foams described herein include 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or 90% by weight, based on the total weight of the foam. In some embodiments, the inorganic filler, for example fly ash, can be present in amounts from 50% to 80% by weight such as from 55% to 80% by weight or from 60% to 75% by weight.

In some embodiments, the inorganic filler can include fly ash and calcium carbonate. When used with fly ash, the amount of calcium carbonate in the foam can be from 0.1% to 15% by weight, based on the weight of the foam. In some embodiments, the foam can include 15% or less, 14% or less, 12% or less, 10% or less, or 8% or less by weight calcium carbonate. In some embodiments, the foam can include 0.1% or greater, 0.5% or greater, 1% or greater, 2% or greater, 3% or greater, or 5% or greater by weight calcium carbonate. In some embodiments, when used with fly ash, the foam can include 1% to 15%, 1% to 10%, or 1% to 8% by weight calcium carbonate.

Optionally, the polyurethane foam can further include an organic filler, such as a recycled polymeric material. Suitable examples include pulverized polymeric foam or recycled rubber material. In certain embodiments, the polyurethane foam includes less than 5% by weight organic filler (e.g., less than 4% by weight organic filler, less than 3% by weight organic filler, less than 2% by weight organic filler, less than 1% by weight organic filler, or less than 0.5% by weight organic filler). In certain embodiments, the polyurethane foam does not include an organic filler.

Optionally, the foam can further comprise a plurality of fibers. The filler can include a plurality of fibers. The fibers can be any natural or synthetic fiber, based on inorganic or organic materials. Inorganic and organic fibers suitable for use with the foam can include glass fibers, basalt fibers, alumina silica fibers, aluminum oxide fibers, silica fibers, carbon fibers, metal fibers, metal and metal-coated fibers, mineral fibers (such as stone wool, slag wool, or ceramic fiber wool), polyalkylene fibers, polyester fibers, polyamide fibers, phenol-formaldehyde fibers, polyvinyl chloride fibers, polyacrylic fibers, acrylic polyester fibers, polyurethane fibers, polyacrylonitrile fibers, rayon fibers, cellulose fibers, carbon fibers, or combinations thereof. In certain embodiments, the fiber material can include hemp fibers, sisal fibers, cotton fibers, straw, reeds, or other grasses, jute, bagasse fibers, bamboo fibers, abaca fibers, flax, southern pine fibers, wood fibers, cellulose, saw dust, wood shavings, lint, vicose, leather fibers, rayon, and mixtures thereof. Other suitable fibers include synthetic fibers such as, Kevlar, viscose fibers, Dralon® fibers, polyethylene fibers, polyethylene terephthalate fibers, polyethylene naphthalate fibers, polypropylene fibers, polyvinyl alcohol fibers, aramid fibers, or combinations thereof. In some embodiments, the fiber material can include glass fibers. Glass fibers can include fibrous glass such as E-glass, C-glass, S-glass, and AR-glass fibers. In some examples, fire resistant or retardant glass fibers can be included to impart fire resistance or retarding properties to the foam. In some embodiments, the foam can include a combination of fibers that break and fibers that do not break when the foam is being formed using processing machinery and/or fractured by external stress. In some embodiments, the fibers can be dispersed within the foam. The fibers in the foam can be present in the form of individual fibers, chopped fibers, bundles, strings such as yarns, fabrics, papers, rovings, mats, or tows. In some embodiments, the foam can include a plurality of glass fibers.

In some embodiments, the average length of the fibers (e.g., the glass fibers) in the foam can be at least 0.1 mm (e.g., at least 0.5 mm, at least 1 mm, at least 1.5 mm, at least 2 mm, at least 2.5 mm, at least 3 mm, at least 3.5 mm, at least 4 mm, at least 4.5 mm, at least 5 mm, at least 10 mm, at least 15 mm, at least 20 mm, at least 25 mm, at least 30 mm, at least 35 mm, at least 40 mm, or at least 45 mm). In some embodiments, the average length of the fibers (e.g., the glass fibers) in the foam can be 50 mm or less (e.g., 45 mm or less, 40 mm or less, 35 mm or less, 30 mm or less, 25 mm or less, 20 mm or less, 15 mm or less, 10 mm or less, 5 mm or less, 4.5 mm or less, 4 mm or less, 3.5 mm or less, 3 mm or less, 2.5 mm or less, 2 mm or less, 1.5 mm or less, 1 mm or less, or 0.5 mm or less).

The fibers can have an average length ranging from any of the minimum values described above to any of the maximum values described above. For example, in some embodiments, the fibers can have an average length of from 0.1 mm to 50 mm (e.g., from 0.1 mm to 30 mm, from 0.1 mm to 10 mm, from 0.1 mm to 5 mm, or from 0.1 mm to 3.5 mm).

In some embodiments, the average diameter of the fibers (e.g., the glass fibers) in the foam can be at least 1 micron (e.g., at least 2 microns, at least 3 microns, at least 4 microns, at least 5 microns, at least 10 microns, at least 15 microns, at least 20 microns, at least 25 microns, at least 30 microns, at least 35 microns, at least 40 microns, or at least 45 microns). In some embodiments, the average diameter of the fibers (e.g., the glass fibers) in the foam can be 50 microns or less (e.g., 45 microns or less, 40 microns or less, 35 microns or less, 30 microns or less, 25 microns or less, 20 microns or less, 15 microns or less, 10 microns or less, 5 microns or less, 4 microns or less, 3 microns or less, or 2 microns or less).

The fibers can have an average diameter ranging from any of the minimum values described above to any of the maximum values described above. For example, in some embodiments, the fibers can have an average diameter of from 1 micron to 50 microns (e.g., from 5 microns to 50 microns). In certain cases, the fibers can have an average diameter equal to from 25% to 100% of the average trabecular thickness of the open cell foam.

The fibers can also be described by its aspect ratio. In some embodiments, the fibers in the foam can have an average aspect ratio of length to diameter of from 8:1 to 2000:1. For example, the fibers can have an average aspect ratio of from 8:1 to 1500:1, 8:1 to 1000:1, 8:1 to 700:1, 5:1 to 2000:1, 5:1 to 1500:1, 5:1 to 1000:1, 5:1 to 750:1, 1.5:1 to 500:1, 1.5:1 to 400:1, 1.5:1 to 300:1, 1.5:1 to 250:1, 2:1 to 200:1, 2.5:1 to 150:1, 3:1 to 100:1, 3.5:1 to 75:1, 4:1 to 50:1, 5:1 to 25:1, 5:1 to 20:1, or 5:1 to 10:1. In some embodiments, the fibers can have an average aspect ratio of length to diameter of 1.5:1 or greater, 2:1 or greater, 3:1 or greater, 4:1 or greater, 5:1 or greater, 7.5:1 or greater, 10:1 or greater, 15:1 or greater, 20:1 or greater, 25:1 or greater, 30:1 or greater, or 40:1 or greater. In some embodiments, the fiber can have an average aspect ratio of length to diameter of 200:1 or less, 150:1 or less, 100:1 or less, 75:1 or less, 50:1 or less, 40:1 or less, 30:1 or less, 20:1 or less, 10:1 or less, or 5:1 or less.

The fibers (when used) can be present in the foam in amounts of 15% or less by weight, based on the weight of foam. For example, the fibers can be present in amounts from 0.25% to 15%, 0.5% to 15%, 1% to 15%, 0.25% to 10%, 0.5% to 10%, 1% to 10%, 0.25% to 8%, 0.25% to 6%, or 0.25% to 4% by weight, based on the weight of the foam. In some embodiments, the foam is free of fibers dispersed within the foam.

Optionally, the foam described herein can comprise additional materials. The additional materials useful with the foam can include foaming agents, blowing agents, chain-extenders, crosslinkers, coupling agents, UV stabilizers, fire retardants, antimicrobials, anti-oxidants, and pigments. Though the use of such components is well known to those of skill in the art, some of these additional additives are further described herein.

Chemical foaming agents include azodicarbonamides (e.g., Celogen manufactured by Lion Copolymer Geismar); and other materials that react at the reaction temperature to form gases such as carbon dioxide. In the case of polyurethane foam, water is an exemplary foaming agent that reacts with isocyanate to yield carbon dioxide. The presence of water as an added component or in the filler also can result in the formation of polyurea bonds through the reaction of the water and isocyanate. In some embodiments, water may be present in the mixture used to produce the foam in an amount of from greater than 0% to 5% by weight or less, based on the weight of the mixture. In some embodiments, water can be present in a range of 0.02% to 4%, 0.05% to 3%, 0.1% to 2%, or 0.2% to 1% by weight, based on the weight of the mixture. In some embodiments, the mixture used to produce the foam includes less than 0.5% by weight water. In some embodiments, no chemical foaming agents are used. In some embodiments, water is the only foaming agent used.

Low molecular weight reactants such as chain-extenders and/or crosslinkers can be included in the foam described herein. These reactants help the foam to distribute and contain the fiber material and/or particulate filler within the composite. Chain-extenders are difunctional molecules, such as diols or diamines, that can polymerize to lengthen the urethane polymer chains. Examples of chain-extenders include ethylene glycol; 1,4-butanediol; ethylene diamine, 4,4′-methylenebis(2-chloroaniline) (MBOCA); diethyltoluene diamine (DETDA); and aromatic diamines such as Unilink 4200 (commercially available from UOP). Crosslinkers are tri- or greater functional molecules that can integrate into a polymer chain through two functionalities and provide one or more further functionalities (i.e., linkage sites) to crosslink to additional polymer chains. Examples of crosslinkers include glycerin, trimethylolpropane, sorbitol, diethanolamine, and triethanolamine. In some foam, a crosslinker or chain-extender may be used to replace at least a portion of the one or more polyols in the foam. For example, the polyurethane can be formed by the reaction of an isocyanate, a polyol, and a crosslinker.

Coupling agents and other surface treatments such as viscosity reducers, flow control agents, or dispersing agents can be added directly to the filler or fiber, or incorporated prior to, during, and/or after the mixing and reaction of the foam. Coupling agents may also reduce the viscosity of the foam mixture. Coupling agents can also allow higher filler loadings of the particulate filler such as fly ash, and/or fiber material, and may be used in small quantities. For example, the foam may comprise about 0.01 wt % to about 0.5 wt % of a coupling agent. Examples of coupling agents useful with the foam described herein include Ken-React LICA 38 and KEN-React KR 55 (Kenrich Petrochemicals; Bayonne, N.J.). Examples of dispersing agents useful with the foam described herein include JEFFSPERSE X3202, JEFFSPERSE X3202RF, and JEFFSPERSE X3204 (Huntsman Polyurethanes; Geismar, La.).

Ultraviolet light stabilizers, such as UV absorbers, can be added to the foam described herein. Examples of UV light stabilizers include hindered amine type stabilizers and opaque pigments like carbon black powder. Fire retardants can be included to increase the flame or fire resistance of the foam. Antimicrobials can be used to limit the growth of mildew and other organisms on the surface of the composite. Antioxidants, such as phenolic antioxidants, can also be added. Antioxidants provide increased UV protection, as well as thermal oxidation protection.

Pigments or dyes can optionally be added to the foam described herein. An example of a pigment is iron oxide, which can be added in amounts ranging from about 2 wt % to about 7 wt %, based on the total weight of the foam.

As described herein, the polyurethane foam can comprise a high filler loading, such as from 50% to 90% by weight of the foam, which can result in an increase in the density of the foam. In some embodiments, it is desirable that the foam has a density below a particular threshold at the desired loadings so it remains relatively lightweight and/or can be effectively processed. In some embodiments, the amount of fibers and/or inorganic filler can be present in the composite mixture in amounts to produce a foam having a density 5 lb/ft³ to 70 lb/ft³. In some embodiments, the density is at least 10 lb/ft³ and/or 35 lb/ft³ or less. For example, the density of the foam can be 10 lb/ft³ to 35 lb/ft³, 15 lb/ft³ to 35 lb/ft³, 15 lb/ft³ to 25 lb/ft³, 10 lb/ft³ to 30 lb/ft³, 10 lb/ft³ to 25 lb/ft³, or 20 lb/ft³ to 30 lb/ft³.

Incorporation of the fibers and/or inorganic filler in a high filler loading can increase the flexural strength of the foam, compared to a foam without the fibers and/or high inorganic filler. It is desirable to provide polyurethane foams that are relatively lightweight and strong enough to be used in various applications such as by itself as a structural material or in place of composite boards or the like. In some embodiments, the flexural strength of the polyurethane foam can be increased by at least 10%, for example, 15% or greater, 20% or greater, 25% or greater, 30% or greater, 35% or greater, 50% or greater, 75% or greater, or even 100% or greater, compared to a foam without fibers and/or high inorganic filler loading.

The flexural strength of the foams described herein can be 100 psi or greater (e.g., up to 700 psi). For example, the flexural strength of the foams can be 200 psi or greater, 300 psi or greater, 400 psi or greater, 500 psi or greater, 600 psi or greater, 700 psi or greater, or 1000 psi or greater. In some embodiments, the flexural strength of the foams can be from 100 to 700 psi. The flexural strength can be determined by the load required to fracture a rectangular prism loaded in the three point bend test as described in ASTM C1185-08 (2012).

The foams can exhibit a ratio of flexural strength (in psi) to density (in lb/ft³) of from 10:1 to 200:1. In some embodiments, the foam can exhibit a ratio of flexural strength (in psi) to density (in lb/ft³) of from 10:1 to 100:1 or from 20:1 to 100:1.

The modulus of elasticity (stiffness) of the foams can be 10 ksi or greater, 15 ksi or greater, 20 ksi or greater, 25 ksi or greater, or 30 ksi or greater. For example, the modulus of elasticity can be from 15 to 30 ksi, from 20 to 30 ksi, or from 22 to 28 ksi. The modulus of elasticity can be determined as described in ASTM C1185-08.

The foams can exhibit a ratio of modulus of elasticity (in ksi) to density (in lb/ft³) of from 1:2 to 2:1. In some embodiments, the foam can exhibit a ratio of modulus of elasticity (in ksi) to density (in lb/ft³) of from 1:2 to 2:1, from 1:1.5 to 1.5:1, or from 1:1.2 to 1.2:1.

The compressive strength of the foams can be 150 psi or greater (e.g., 175 psi or greater, 200 psi or greater, 220 psi or greater, 240 psi or greater, 250 psi or greater, 260 psi or greater, 280 psi or greater, or 300 psi or greater). For example, the foams can exhibit a compressive strength of from 150 to 300 psi (e.g., from 200 to 250 psi, from 175 to 250 psi, or from 220 to 240 psi). The compressive strength can be determined as described in ASTM D1621. The foam can exhibit a ratio of compressive strength (in psi) to density (in lb/ft³) of from 7:1 to 25:1. In some embodiments, the foam can exhibit a ratio of compressive strength (in psi) to density (in lb/ft³) of from 8:1 to 15:1.

Reinforced Polyurethane Foams

Composite panels comprising the polyurethane foam are described herein. In some embodiments, the composite panel can include a first fiber reinforcement; a polyurethane foam having a first surface and a second surface opposite the first surface, wherein the first surface is in contact with the first fiber reinforcement; and a cementitious material adjacent the first fiber reinforcement opposite the foam.

The fiber reinforcement can include any of the fiber materials as described herein and can include a blend of different fibers (either type or size). In some embodiments, the fiber reinforcement can include glass fibers. In some embodiments, the fibrous glass is a low alkalinity fiber such as an E-glass fiber. The fiber reinforcement can be woven or non-woven. In some embodiments, the fiber reinforcement can be present in the form of individual fibers, chopped fibers, bundles, strings such as yarns, fabrics, scrims, papers, rovings, mats, or tows.

The fibers in the reinforcement can have an average diameter of 100 microns or less. For example, the fibers in the fiber reinforcement can have an average diameter of 1 μm or greater, 2 μm or greater, 3 μm or greater, 4 μm or greater, 5 μm or greater, 10 μm or greater, 15 μm or greater, 20 μm or greater, 25 μm or greater, 30 μm or greater, 40 μm or greater, 50 μm or greater, 60 μm or greater, 70 μm or greater, 80 μm or greater, 90 μm or greater, or 100 μm or greater. In some embodiments, the fibers in the fiber reinforcement can have an average diameter of 90 μm or less, 80 μm or less, 70 μm or less, 60 μm or less, 50 μm or less, 40 μm or less, 30 μm or less, 25 μm or less, or 20 μm or less. In certain embodiments, the fibers in the fiber reinforcement can have an average diameter of from 1 μm to 100 μm, 1 μm to 70 μm, 1 μm to 50 μm, 1 μm to 25 μm, 5 μm to 100 μm, 5 μm to 50 μm, 5 μm to 25 μm, or 5 μm to 20 μm.

The thickness of the fiber reinforcement on the foam can be any suitable thickness to reinforce the foam. In some embodiments, the average thickness of the fiber reinforcement can be 0.1 inch or less. For example, the fiber reinforcement can have an average thickness of 0.07 inch or less, 0.05 inch or less, 0.03 inch or less, 0.01 inch or less, 0.005 inch or less, or 0.001 inch or less. In some embodiments, the fiber reinforcement can have an average thickness of 0.001 inch or greater, 0.005 inch or greater, 0.01 inch or greater, 0.03 inch or greater, 0.05 inch or greater, or 0.07 inch or greater. In some embodiments, the fiber reinforcement can have an average thickness of from 0.001 inch to 0.1 inch or from 0.001 inch to 0.05 inch.

The fiber reinforcement can have a basis weight of 20 g/ft² or less. In some embodiments, the fiber reinforcement can have a basis weight of 17 g/ft² or less, 15 g/ft² or less, 12 g/ft² or less, 10 g/ft² or less, 9 g/ft² or less, 8 g/ft² or less, 7 g/ft² or less, 6 g/ft² or less, or 5 g/ft² or less. In some embodiments, the fiber reinforcement can have a basis weight of 0.5 g/ft² or greater, 1 g/ft² or greater, 2 g/ft² or greater, 3 g/ft² or greater, 4 g/ft² or greater, 5 g/ft² or greater, 7 g/ft² or greater, or 10 g/ft² or greater. In some embodiments, the fiber reinforcement can have a basis weight of from 0.5 g/ft² to 20 g/ft², from 0.5 g/ft² to 15 g/ft², from 0.5 g/ft² to 10 g/ft², from 1 g/ft² to 10 g/ft², or from 1.5 g/ft² to 10 g/ft².

As described herein, the composite panel can include a cementitious material. In some embodiments, the cementitious material can form a layer adjacent the first fiber reinforcement, opposite the foam. The cementitious material can include any suitable material for forming a cementitious layer with the desirable properties. In some embodiments, the cementitious material includes a rapid set cement. The rapid set cement can include calcium aluminate cement (CAC), calcium phosphate cement, calcium sulfate hydrate, calcium sulfoaluminate (CSA) cement, magnesium oxychloride cement, magnesium oxysulfate cement, magnesium phosphate cement, or combinations thereof. In some embodiments, the cementitious material can include Portland cement. The rapid set cement and/or the Portland cement can be present in an amount of 50% or greater by weight, e.g., 60% or greater, 70% or greater, 80% or greater, or 90% or greater by weight, based on the total weight of the cementitious material. In some embodiments, the cementitious material does not include gypsum (calcium sulfate hydrate).

In some embodiments, the cementitious material can include an inorganic polymer formed by reacting a reactive powder and an activator in the presence of water. Suitable inorganic polymers are described in U.S. Patent No. U.S. Patent Application No. 2014/0349104, which is herein incorporated by reference. In some embodiments, the reactive powder for use in the cementitious material includes fly ash. In some examples, the majority of the fly ash present is Class C fly ash (i.e., greater than 50% of the fly ash present is Class C fly ash).

The fly ash is the principal component of the reactive powder and can be present in an amount of greater than 50% by weight, 65% by weight or greater, 75% by weight or greater, or 85% by weight or greater of the reactive powder. In some examples, the fly ash is present in an amount of 90% by weight or greater of the reactive powder or 95% by weight or greater of the reactive powder. For example, the fly ash can be present in an amount of 85% by weight or greater, 86% by weight or greater, 87% by weight or greater, 88% by weight or greater, 89% by weight or greater, 90% by weight or greater, 91% by weight or greater, 92% by weight or greater, 93% by weight or greater, 94% by weight or greater, 95% by weight or greater, 96% by weight or greater, 97% by weight or greater, 98% by weight or greater, or 99% by weight or greater based on the weight of the reactive powder. In some embodiments, the reactive powder consists of or consists essentially of fly ash.

The reactive powder for use as a reactant to form the inorganic polymer compositions can further include other cementitious components. In some embodiments, the reactive powder can include a rapid set cement as described herein. In some embodiments, the reactive powder can include Portland cement. In some embodiments, the reactive powder further includes slag. In some embodiments, the reactive powder further includes sand. In some embodiments, the reactive powder includes Portland cement, calcium aluminate cement, calcium sulfoaluminate cement, and/or slag. In these examples, the reactive powder can include 10% or less by weight of the other cementitious material. In some examples, the reactive powder includes 5% by weight or less, 3% by weight or less, or 1% by weight or less of other cementitious material. For example, the reactive powder can include the other cementitious material cement in an amount of 10% or less by weight, 9% or less by weight, 8% or less by weight, 7% or less by weight, 6% or less by weight, 5% or less by weight, 4% or less by weight, 3% or less by weight, 2% or less by weight, 1% or less by weight, or 0.5% or less by weight. In some examples, the reactive powder is substantially free from other cementitious material. For example, the reactive powder can include less than 0.1% by weight, less than 0.01% by weight, or less than 0.001% by weight of Portland cement based on the weight of the reactive powder. In some embodiments, the reactive powder includes no Portland cement.

The reactive powder can also include a ground slag such as blast furnace slag in an amount of 10% or less by weight. For example, the reactive powder can include slag in an amount of 10% or less, 9% or less, 8% or less, 7% or less, 6% or less, 5% or less, 4% or less, 3% or less, 2% or less, or 1% or less by weight.

An activator is a further reactant used to form the inorganic polymer compositions described herein. The activator allows for rapid setting of the inorganic polymer compositions and also imparts compressive strength to the compositions. The activator can include one or more of acidic, basic, and/or salt components. For example, the activator can include citrates, hydroxides, metasilicates, carbonates, aluminates, sulfates, and/or tartrates. The activator can also include other multifunctional acids that are capable of complexing or chelating calcium ions (e.g., EDTA). Specific examples of suitable citrates for use as activators include citric acid and its salts, including, for example, sodium citrate and potassium citrate. Specific examples of suitable tartrates include tartaric acid and its salts (e.g., sodium tartrate and potassium tartrate). In some examples, the activator can include alkali metal hydroxides, such as sodium hydroxide and potassium hydroxide. Further examples of suitable activators include metasilicates (e.g., sodium metasilicate and potassium metasilicate); carbonates (e.g., sodium carbonate and potassium carbonate); aluminates (e.g., sodium aluminate and potassium aluminate); and sulfates (e.g., sodium sulfate and potassium sulfate). In some examples, the activator includes citric acid, tartaric acid, or mixtures thereof. In some examples, the activator includes sodium hydroxide. In some examples, the activator includes a mixture of citric acid and sodium hydroxide. In examples including a mixture of citric acid and sodium hydroxide, the weight ratio of citric acid present in the mixture to sodium hydroxide present in the mixture is from 0.4:1 to 2.0:1, 0.6:1 to 1.9:1, 0.8:1 to 1.8:1, 0.9:1 to 1.7:1, or 1.0:1 to 1.6:1. The activator components can be pre-mixed prior to being added to the other reactive components in the inorganic polymer or added separately to the other reactive components. For example, citric acid and sodium hydroxide could be combined to produce sodium citrate and the mixture can include possibly one or more of citric acid and sodium hydroxide in stoichiometric excess. In some embodiments, the activator includes a stoichiometric excess of sodium hydroxide. The total amount of activators can include less than 95% by weight of citrate salts. For example, the total amount of activator can include from 25-85%, 30-75%, or 35-65% citrate salts by weight. The mixture in solution and the mixture when combined with the reactive powder can have a pH of from 12 to 13.5 or about 13.

The activator can be present as a reactant in an amount of from 1.5% to 8.5% dry weight based on the weight of the reactive powder. For example, the activator can be present in an amount of from 2% to 8%, from 3% to 7%, or from 4% to 6%. In some examples, the activator can be present in an amount of 1.5%, 2%, 2.5%, 3%, 3.5%, 4%, 4.5%, 5%, 5.5%, 6%, 6.5%, 7%, 7.5%, 8% or 8.5% dry weight based on the weight of the reactive powder. For example, when sodium hydroxide and citric acid are used as the activators, the amount of sodium hydroxide used in the activator solution can be from 0.3 to 15.6, 0.5 to 10, 0.75 to 7.5, or 1 to 5 dry parts by weight based on the weight of reactive powder and the amount of citric acid used in the activator solution can be from 0.25 to 8.5, 0.5 to 0.7, 0.75 to 0.6, or 1 to 4.5 dry parts by weight based on the weight of reactive powder. The resulting activator solution can include sodium citrate and optionally one or more of citric acid or sodium hydroxide.

The activator can be provided, for example, as a solution. In some examples, the activator can be provided in water as an aqueous solution in a concentration of from 10% to 50% or from 20% to 40% based on the weight of the solution. For example, the concentration of the activator in the aqueous solution can be from 25% to 35% or from 28% to 32% based on the weight of the solution. Examples of suitable concentrations for the activator in the aqueous solution include 10%, 15%, 20%, 25%, 30%, 35%, 40%, 45%, or 50% based on the weight of the solution.

The inorganic polymer compositions described herein are prepared in the presence of aerating agents, including blowing agents and foaming agents. Examples of suitable blowing agents include aluminum powder, perborates (e.g., sodium perborate), peroxides (e.g., H₂O₂ or an organic peroxide), and chloride dioxide. The blowing agent can be present in an amount of from 0.1% to 10% by weight of the reactive powder. The aerating agents described herein can also include foaming agents. In some examples, the foaming agent can be an air-entraining agent. Foaming agents can be used to help the system maintain air or other gases, e.g., from the mixing process. The foaming agents can include non-ionic surfactants, anion surfactants, and/or cationic surfactants. Examples of suitable foaming agents include sodium alkyl ether sulfate, ammonium alkyl ether sulfate, sodium alpha olefin sulfonate, sodium deceth sulfate, ammonium deceth sulfate, sodium laureth sulfate, and sodium dodecylbenzene sulfonate. The foaming agents can be provided in an amount of 0.1% or less based on the weight of the reactive powder. In some examples, the foaming agents can be included in the compositions in an amount of from 0.001% by weight to 0.1% by weight or from 0.005% by weight to 0.05% by weight (e.g., 0.01% by weight).

The reactants to form the inorganic polymer compositions are reacted in the presence of water. The water can be provided in the reactive mixture by providing the activator in solution and/or by adding water directly to the reactive mixture. The solution to binder or solution to reactive powder weight ratio (i.e., the ratio of the solution including activator to reactive powder) can be from 0.09:1 to 0.5:1, depending on the product being made and the process being used for producing the product.

The reactants used to form the inorganic polymer compositions can further include a retardant. Retardants are optionally included to prevent the composition from stiffening too rapidly, which can result in a reduction of strength in the structure. Examples of suitable retardants for inclusion as reactants include borax, boric acid, gypsum, phosphates, gluconates, or a mixture of these. In some examples, the retardant is present in an amount of from 0.4% to 7.5% based on the weight of the reactive powder.

The cementitious material can include a filler, such as those described herein. In some examples, the cementitious material can include a rapid set cement, Portland cement, and a filler such as fly ash, slag, sand, or combinations thereof. In some embodiments, the cementitious material can include a rapid set cement and a filler such as fly ash, slag, or sand. In some examples, the cementitious material can include Portland cement and a filler. In some examples, the cementitious material consists or consists essentially of a rapid set cement, a filler in an amount of 30% or less by weight (e.g., 25% or less by weight, or 20% or less by weight), based on the total weight of the cementitious material, and optionally Portland cement. In some examples, the filler (e.g., fly ash, slag, sand, or combinations thereof) can be present in an amount of from 5% to 30% by weight, based on the total weight of the cementitious material. In some examples, the filler can include a lightweight filler.

In some embodiments, a cementitious material can include a fiber material, e.g., to provide increased strength, stiffness or toughness. In some examples, fire resistant or retardant glass fibers can be included to impart fire resistance or retarding properties to the cementitious material. Suitable fiber materials useful with the cementitious material are described herein. The fibers can be included in an amount of 0.1% to 6% based on the weight of the cementitious material.

Additional components useful with the cementitious material described herein include air entraining agents, water reducers, plasticizers, pigments, anti-efflorescence agents, ultraviolet light stabilizers, retardants including fire retardants, antimicrobials, and antioxidants. Air entraining agents can be used to entrain air in the cementitious material thereby reducing the density of the cementitious material. Water reducers can be included in the compositions described herein to reduce the amount of water in the composition while maintaining the workability, fluidity, and/or plasticity of the composition. In some examples, the water reducer is a high-range water reducer, such as, for example, a superplasticizer admixture. Examples of suitable water reducers include lignin, naphthalene, melamine, polycarboxylates, lignosulfates and formaldehyde condensates (e.g., sodium naphthalene sulfonate formaldehyde condensate). Water reducers can be provided in an amount of from greater than 0 to 1% by weight based on the weight of the cementitious material.

The cementitious material can further include a photocatalyst. Photocatalysts are optionally included for the reduction of nitrogen oxides (NOx) and self-cleaning. In some embodiments, the cementitious material can include titanium dioxide. Example of suitable photocatalyst includes titanium dioxide. In some embodiments, the photocatalyst can be dispersed within the cementitious material. In some embodiments, the photocatalyst can be present as a coating on the cementitious material. In some examples, the titanium dioxide can be provided as a coating on the cementitious material and is present in an amount of from 1% to 10% based on the weight of the coating on the cementitious material.

The cementitious material can be any suitable thickness to confer a desirable property to the composite panel, e.g., to provide increased strength, handleability, stiffness or toughness. In some embodiments, the thickness of the cementitious material can be 0.5 inch or less. For example, the cementitious material can have an average thickness of 0.4 inch or less, 0.3 inch or less, 0.25 inch or less, 0.20 inch or less, or 0.15 inch or less. In some embodiments, the cementitious material can have an average thickness of 0.005 inch or greater, 0.01 inch or greater, 0.05 inch or greater, or 0.1 inch or greater. In some embodiments, the cementitious layer can have an average thickness of from 0.005 inch to 0.25 inch or from 0.005 inch to 0.20 inch.

In some embodiments, the fiber material (including the fiber reinforcement), the cementitious material, and/or the particulate filler such as fly ash can be coated with a composition to modify their reactivity. For example, the fiber material, the cementitious material, and/or the particulate filler can be coated with a sizing agent such as a coupling agent (compatibilizer). In some embodiments, the fiber material, the cementitious material, and/or the particulate filler can be coated with a composition for promoting adhesion. U.S. Pat. No. 5,064,876 to Hamada et al. and U.S. Pat. No. 5,082,738 to Swofford, for example, disclose compositions for promoting adhesion. U.S. Pat. No. 4,062,999 to Kondo et al. and U.S. Pat. No. 6,602,379 to Li et al. describe suitable aminosilane compounds for coating fibers. In some embodiments, the fiber material, the cementitious material, and/or the particulate filler are surface coated with a composition comprising a silane compound such as aminosilane. In some embodiments, the fiber material, the cementitious material, and/or the particulate filler are surface coated with a composition comprising an oil, starch, or a combination thereof.

As described herein, the composite panel can include a first fiber reinforcement on a first surface of the foam and a second fiber reinforcement on a second surface, opposite the first surface, of the foam. In some embodiments, the composite panel can include a first fiber reinforcement on a first surface of the foam and a material, other than a fiber reinforcement, on a second surface of the foam. In some embodiments, the material can include a cementitious layer, a paper sheet, a metal sheet, a polymeric layer, or a combination thereof. Suitable materials that can be included on the second surface of the foam include an aluminum sheet, an aluminum-plated sheet, a zinc sheet, a zinc-plated sheet, an aluminum/zinc alloy sheet, an aluminum/zinc alloy-plated sheet, a stainless steel sheet, craft paper, a polymeric surfacing film, or a combination thereof.

Methods

Methods of preparing the polyurethane foams are described herein. The polyurethane foam can be produced using a batch, semi-batch, or continuous process. In some embodiments, the method can include forming a polyurethane mixture. The polyurethane mixture can be produced by mixing the one or more isocyanates, the one or more polyols, and the filler in a mixing apparatus. The materials can be added in any suitable order. For example, in some embodiments, the mixing stage of the method used to prepare the foam can include: (1) mixing the polyol and filler; (2) mixing the isocyanate with the polyol, and filler; and optionally (3) mixing the catalyst with the isocyanate, the polyol, and the filler. In some embodiments, the mixture can include less than 0.1% by weight surfactant, based on the total weight of the mixture (e.g., less than 0.05% by weight surfactant, less than 0.01% by weight surfactant, less than 0.005% by weight surfactant, or less than 0.001% by weight surfactant). In certain embodiments, the mixture does not include a surfactant.

The polyurethane mixture can be blended in any suitable manner to obtain a homogeneous or heterogeneous blend of the one or more isocyanate, the one or more polyols, the filler, and catalyst. In some embodiments, mixing can be conducted in a high speed mixer or an extruder. The method can include applying shear to the mixture to disperse the filler in the mixture. An ultrasonic device can be used for enhanced mixing and/or wetting of the various components of the composite. The ultrasonic device produces an ultrasound of a certain frequency that can be varied during the mixing and/or extrusion process. The ultrasonic device useful in the preparation of composite panels described herein can be attached to or adjacent to the extruder and/or mixer. For example, the ultrasonic device can be attached to a die or nozzle or to the port of the extruder or mixer. An ultrasonic device may provide de-aeration of undesired gas bubbles and better mixing for the other components, such as blowing agents, surfactants, and catalysts.

The method of making the foam can include allowing the one or more isocyanates and the one or more polyols to react in the presence of the filler. The curing stage of the method used to prepare the foam can be carried out in a mold cavity of a mold, the mold cavity formed by at least an interior mold surface. In some embodiments, a molded article can then be formed prior to the additional method steps in forming the composite panel.

In some embodiments, the one or more polyols, one or more isocyanates, or a mixture thereof, and the filler can be included in amounts, which results in a decrease in the viscosity of the polyurethane mixture, and thus improves the processability of such materials and products. In some embodiments, it is desirable that the polyurethane mixture has a viscosity below a particular threshold at the desired loadings so it can be effectively processed. In some embodiments, the amount of one or more polyols, one or more isocyanates, or a mixture thereof, and the filler can be present in the mixture in amounts to produce a workable viscosity (initial viscosity) of from 100,000 cps or less. In some embodiments, the mixture can be applied to the mold at a viscosity of from 5,000 to 100,000 cps or from 20,000 to 100,000 cps at the temperature of the mixture. The viscosity of the composite mixture can be measured using a Thermo Electron Corporation Haake Viscometer.

In some embodiments, the polyurethane mixture can be foamed. The method of making the polyurethane foams can include allowing the mixture to expand via a gas phase to form a foam having a first surface and a second surface opposite the first surface. The gas phase can be generated in situ from reaction of water with the one or more isocyanates. The gas can be introduced into the polyurethane mixture. Suitable gases are known in the art. In some embodiments, the gas can be captured after gelation (i.e., formation) of the foam.

The foaming action of the polyurethane foams can be described as having a “cream time,” during which foaming is initiated and the mixture reaches a consistency of a soft creamy foam, a “firm time” at which the foam sets up and hardens, and a “tack free time” at which time surface no longer feels sticky. The cream time of the polyurethane can be 40 seconds or longer, 60 seconds or longer, or 80 seconds or longer. For example, the cream time of the polyurethane can be 40 seconds to 120 seconds or from 80 seconds to 120 seconds. The tack free time of the polyurethane can be 2 minutes or longer, 3 minutes or longer, 4 minutes or longer, or 5 minutes or longer and/or 7 minutes or less, 6 minutes or less, 5 minutes or less, or 4 minutes or less. For example, the tack free time of the polyurethane can be 2 minutes to 7 minutes or from 3 minutes to 6 minutes. In some embodiments, the polyurethane foam reaches a hardness of 20 shore D at no less than 5 minutes. For example, the polyisocyanurate or polyurethane foam does not reach a hardness of 20 shore D in less than 5 minutes. For example, the polyurethane foam does not reach a hardness of 20 shore Din less than 7.5 minutes, less than 10 minutes, less than 12.5 minutes, less than 15 minutes, less than 17.5 minutes, or less than 20 minutes. The Shore D hardness can be determined using a durometer as described in ASTM D2240.

In some cases, the mixture can be allowed to rise freely during foaming in the mold. In some cases, the mixture can be placed under the pressure of a mold cavity prior to or during the foaming of the polyurethane foam. After the polyurethane foam is formed, the method can include removing the foam from the mold.

Methods of making composite panels from the polyurethane foams are also described herein. The method can include applying a first fiber reinforcement to a surface of the foam. In some embodiments, the fiber reinforcement can be applied to the foam before it has completely cured, such that at least a portion of the fiber reinforcement becomes embedded in the foam. For example, the fiber reinforcement can be applied to the polyurethane mixture after the mixture is fed to the mold. In some embodiments, the fiber reinforcement can be applied to the mold prior to the mixture being fed into the mold and can become embedded prior to the full curing of the mixture. In some embodiments, the fiber reinforcement can be applied to the foam after the polyurethane has been cured. For example, an adhesive can be applied to bond the fiber reinforcement to the foam. The adhesive can be applied by spray coating, curtain coating, brushing, roller coating, dip coating, spin coating, or flow coating. Suitable adhesives include an adhesive derived from ethylene vinyl acetate, acrylic, urethane, epoxy, starch, gum, resin (such as gum arabic, gum tragacanth, rubber or shellac), or combinations thereof.

The method can further include applying a cementitious material to the fiber reinforcement. The cementitious material can be in the form of a cementitious slurry. The cementitious slurry can be applied by roller coating, curtain coating, dip coating, brushing, with a trowel, or spraying. In some embodiments, the application of the cementitious material can be vacuum assisted. In some embodiments, the method can include applying the cementitious slurry to the fiber reinforcement, after applying the fiber reinforcement to the foam. In some embodiments, the cementitious material and the fiber reinforcement can be applied to the foam simultaneously. For example, the method can include applying a cementitious slurry to the fiber reinforcement prior to applying the fiber reinforcement to the foam. In this example, at least a portion of the fiber reinforcement becomes embedded in the cementitious material.

In some embodiments, the method can include applying the cementitious slurry to the foam, prior to applying the fiber reinforcement to the foam.

The method of making the composite panels can include applying an adhesive to the fiber reinforcement or the foam prior to applying the cementitious material to facilitate bonding of the cementitious material. The adhesive can be applied by spray coating, curtain coating, brushing, roller coating, dip coating, spin coating, or flow coating. Suitable adhesives are described herein.

In some embodiments, the method can include applying a water and/or water vapor barrier prior to applying the cementitious material. For example, the adhesive can produce a water and/or water vapor barrier. Alternatively, a water and/or water vapor barrier film or other material can be applied prior to applying the cementitious material.

In some embodiments, the cementitious material, the first fiber reinforcement, and the foam are directly adhered without the use of an adhesive layer. In embodiments wherein the cementitious slurry and the first fiber reinforcement are directly bonded to a fly ash-filled foam, it has been discovered that the cementitious slurry forms mechanical bonds with the fly ash present in the foam thereby enhancing the bonding of the cementitious slurry and the first fiber reinforcement to the foam.

In some embodiments, the method can include applying a liquid to a surface of the foam to activate the cementitious slurry. In certain embodiments, the liquid can be an aqueous solution having a pH of 6.5 or greater. The liquid optionally includes an activator. Suitable activators are described herein.

In some embodiments, incorporation of the fiber reinforcement and/or the cementitious layer onto the filled foam can maintain similar or improved physical properties and mechanical performance such as flexural strength, hardness, stiffness, flame resistance, and handleability of such materials, when the fiber reinforcement and/or the cementitious layer is excluded from or included in minor amounts in the foam. The optimization of various properties of the composite panels, such as hardness, stiffness, flexural strength, handleability, and flame resistance of the foams allows their use in building materials and other structural applications. For example, the composite panels can be formed into shaped articles and used in building materials. Suitable building materials include building panels, tile backer board, sheathing, roofing products, siding materials, sheets, sound barrier/insulation, thermal barriers, insulation, decking materials, fencing materials, cladding, or other shaped articles. Examples of shaped articles made using the composite panels described herein include roof tiles such as roof tile shingles, roof cover boards, slate panels, shake panels, cast molded products, moldings, sills, stone, masonry, brick products, posts, signs, guard rails, retaining walls, park benches, tables, slats, corner arches, columns, wall boards, ceiling tiles, ceiling boards, soffits, or railroad ties.

In some embodiments, incorporation of the fiber reinforcement on the filled foam to form the composite panels can increase the flexural strength of the foam, compared to a foam without the fiber reinforcement. In some embodiments, the flexural strength of the foam can be increased by at least 10%, for example, 15% or greater, 20% or greater, 25% or greater, 30% or greater, 35% or greater, 50% or greater, 75% or greater, or even 100% or greater, compared to a foam without the fiber reinforcement. The flexural strength of the composite panels described herein can be 200 psi or greater (e.g., up to 1600 psi). For example, the flexural strength of the composite panels can be 300 psi or greater, 500 psi or greater, 700 psi or greater, 900 psi or greater, 1000 psi or greater, 1100 psi or greater, 1200 psi or greater, 1300 psi or greater, 1400 psi or greater, or 1500 psi or greater. The flexural strength can be determined by the load required to fracture a rectangular prism loaded in the three point bend test as described in ASTM C1185-08 (2012).

In some embodiments, incorporation of the fiber reinforcement and the cementitious layer on the filled polyurethane foam can increase the hardness of the foam, compared to a composite without the fiber reinforcement and the cementitious layer. In some embodiments, the Shore D hardness of the composite panels described herein can be 50 or greater (e.g., up to 90). For example, the Shore D hardness of the composite panels can be 55 or greater, 60 or greater, 65 or greater, 75 or greater, or 80 or greater. The Shore D hardness can be determined using a durometer as described in ASTM D2240.

In some embodiments, incorporation of the fiber reinforcement and the cementitious layer on the foam can increase the stiffness of the composite, compared to a composite without the fiber reinforcement and the cementitious layer. In some embodiments, the modulus of elasticity (stiffness) of the composite panel can be 10 ksi or greater, 50 ksi or greater or 100 ksi or greater. For example, the modulus of elasticity can be from 10 to 500 ksi or from 50 to 500 ksi. The modulus of elasticity can be determined as described in ASTM C1185-08.

In some embodiments, incorporation of the fiber reinforcement and the cementitious layer on the filled foam can increase the flame resistance of the composite, compared to a composite without the fiber reinforcement and the cementitious layer. In some embodiments, the composite panels can be qualified as a Class A material in the ASTM E84 tunnel test. In some embodiments, the composite panels have a flame spread rating of 25 or less and a smoke development rating of 450 or less. The flame spread and smoke development ratings can be determined as described in the ASTM E84 test.

### EXAMPLES

Polyurethane foams 1-3 were prepared using the components detailed in Table 1 below. The components were mixed in a vortex mixer and poured in a box mold. The foam was then allowed to rise and cure. Slices of the foam cut perpendicularly to the direction of the rise were used for mechanical testing.

TABLE 1
Components used to form polyurethane foams 1-3.

| | Polyurethane Foam | | |
|---|---|---|---|
| | #1 | #2 | #3 |
| Polyol | 12.14 | 12.14 | 12.10 |
| (CARPOL ® SPA-357) | | | |
| Water | 0.14 | 0.14 | 0.14 |
| Surfactant | — | 0.04 | 0.37 |
| | | (0.3 phpp) | (3 phpp) |
| Isocyanate | 12.71 | 12.71 | 12.67 |
| Fly ash | 75.00 | 74.97 | 74.72 |

X-ray microtomography (micro-CT) studies of polyurethane foams 1-3 were performed using a SkyScan 1172 high resolution desk-top micro-CT commercially available from Bruker Micro-CT (Kontich, Belgium). Samples of each foam were stabilized with parafilm and scanned in air with the following settings: 40 kV, 250 uA, 0.25° rotation step, 6 frame averaging 42000×2672 CCD, 1100 msec exposure and 3 micron voxel size. Scan time was 2 hours 28 minutes. The Volume of Interest (VOI) was a 4 mm cube within each sample. The orientation was random.

Data analysis was performed as follows. First, the material was isolated from the pore space. Then, the greyscale image was converted to binary. Next, material smaller than 10 voxels in 3D (unconnected material/noise) was removed. 3D analysis followed by the 2D analysis was then conducted. Morphometric analyses were performed on both the material and the pore space in 3D and 2D. Each pixel-intensity value was measured on an 8-bit scale, which corresponds to 256 unique values.

### RESULTS

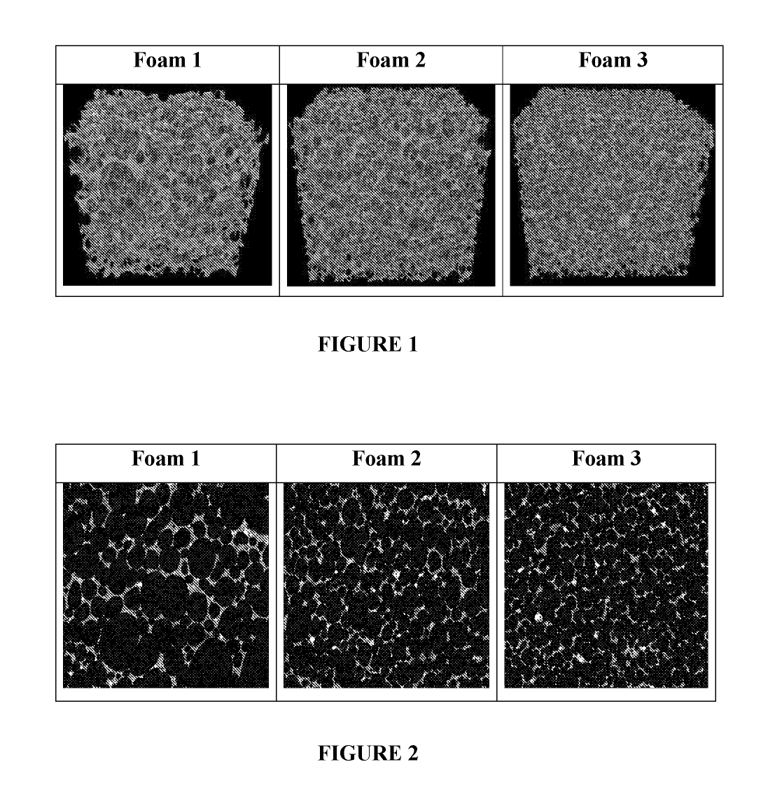

FIG. 1 shows 3-dimensional renderings of the microstructure of polyurethane foams 1-3 obtained from micro-CT studies. FIG. 2 shows 2-dimensional cross-sectional images of the microstructure of polyurethane foams 1-3 obtained from micro-CT studies. As shown in FIGS. 1 and 2, foams 1-3 all possess an open cell structure. However, aspects of the microstructure of foams 1-3, including average trabecular separation, distribution of trabecular separation, and average trabecular thickness, differ significantly.

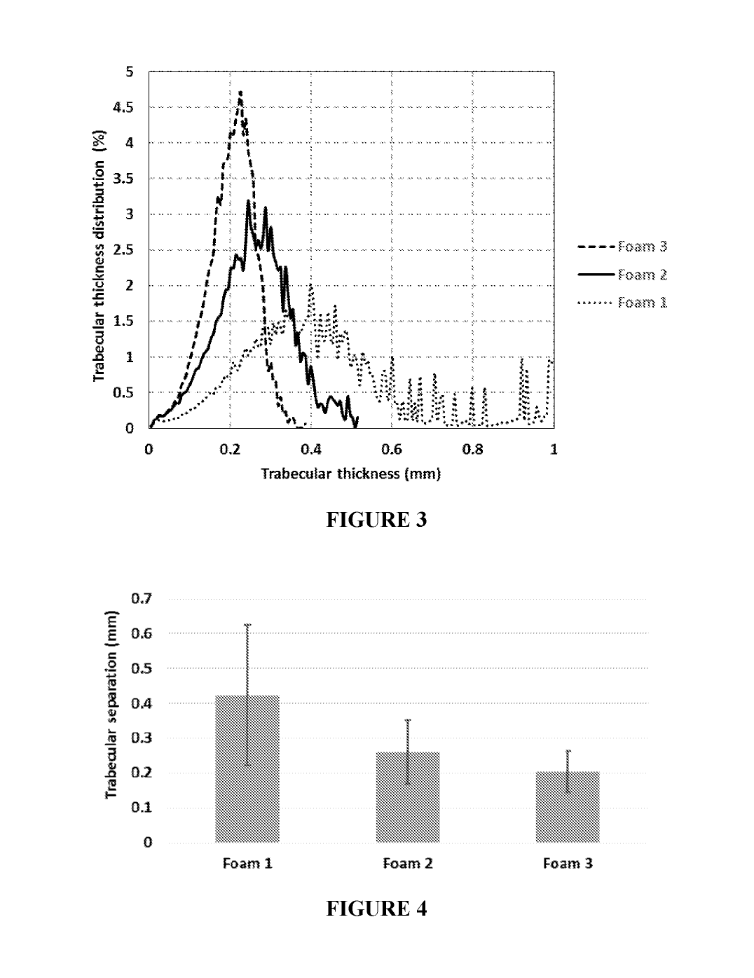

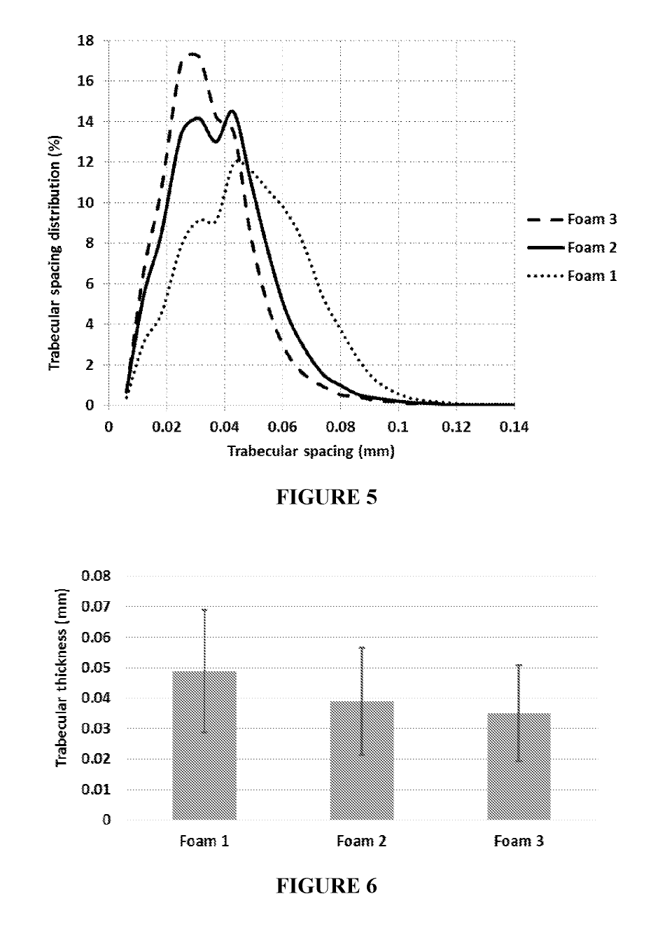

FIG. 3 is a plot showing the distribution of trabecular separation in foams 1-3. FIG. 4 is a histogram plotting the average trabecular separation in foams 1-3. Foam 1 exhibits a much larger average trabecular separation (423 microns) than foam 2 (260 microns) or foam 3 (203 microns). Further, foam 1 exhibits a much broader distribution in trabecular separation than foams 2 and 3. The standard deviation of the trabecular separation in foams 1-3 is also plotted in FIG. 4. The standard deviation of the trabecular separation in foam 1 (201 microns; 47.5% of the average trabecular separation) is significantly larger than the standard deviation of the trabecular separation in foam 2 (92 microns; 35.4% of the average trabecular separation) or foam 3 (59 microns; 29.1% of the average trabecular separation). FIG. 5 is a plot showing the distribution of trabecular thickness in foams 1-3. FIG. 6 is a histogram plotting the average trabecular thickness in foams 1-3. Foam 1 also exhibits a larger average trabecular thickness (49 microns) than foam 2 (39 microns) or foam 3 (35 microns).

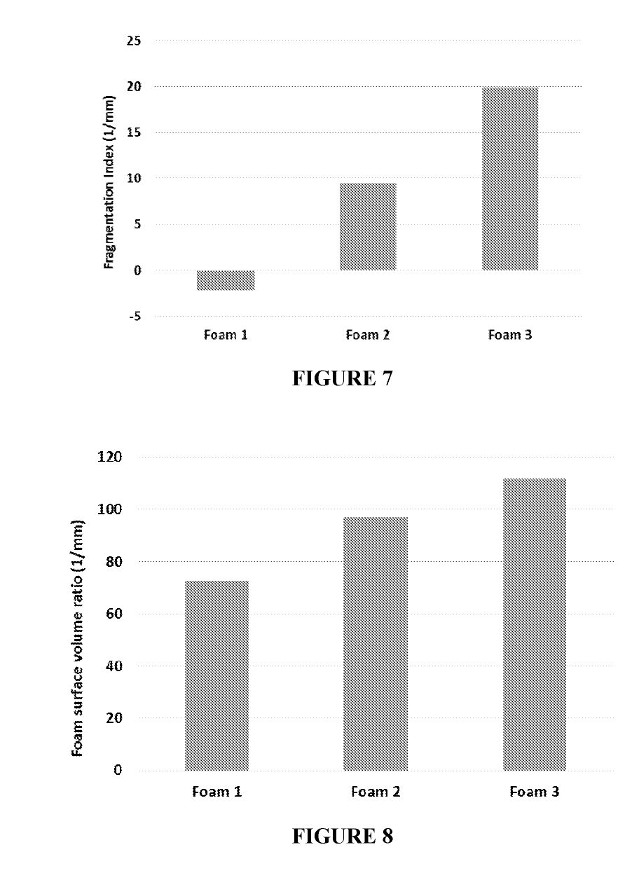

The fragmentation indices of foams 1-3 were also evaluated. Structural connectedness results in enclosed spaces and concave pore perimeters. Dilation of such perimeters will contract them, resulting in a reduced perimeter. In contrast, open ends or nodes, which include convex perimeters, will have their surface expanded by surface dilation, thus resulting in an increased perimeter. As a result, a lower fragmentation index signifies a better connected wall and strut lattice throughout the foam while a higher fragmentation index signifies a more disconnected foam structure. A prevalence of enclosed cavities and concave surfaces can push the fragmentation index to negative values. FIG. 7 is a histogram plotting the fragmentation index of foams 1-3. Foam 1 exhibit a negative fragmentation index (−2.16) whereas foams 2 and 3 exhibit significantly larger, positive fragmentation indices (9.5 and 19.91, respectively). This suggests that foam 1 possesses a more robust network of walls and struts throughout the foam because in both cases the struts are concave but in the case of Foam 1 the struts are thicker and more continuous.

The foam surface is the surface area of all solid portions of the foam with the volume of interest measured in two dimensions using the Pratt algorithm. Pratt, W. K. “Chapter 17—Image Segmentation.” Digital Image Processing, 4^{th} Edition, New York: Wiley; 1991: 579-622. When evaluating the surface in two dimensions from a three dimensional dataset, two components were considered: (1) the perimeters of bisected objects on each cross-sectional level; and (2) the vertical surfaces exposed by pixel differences between adjacent cross-sections. The ratio of foam surface to volume was then calculated for each of foams 1-3. FIG. 8 is a histogram plotting the foam surface to volume ratio of foams 1-3. Foam 1 exhibit a much smaller foam surface to volume ratio (72.7) than foam 2 (96.9) or foam 3 (111.7).

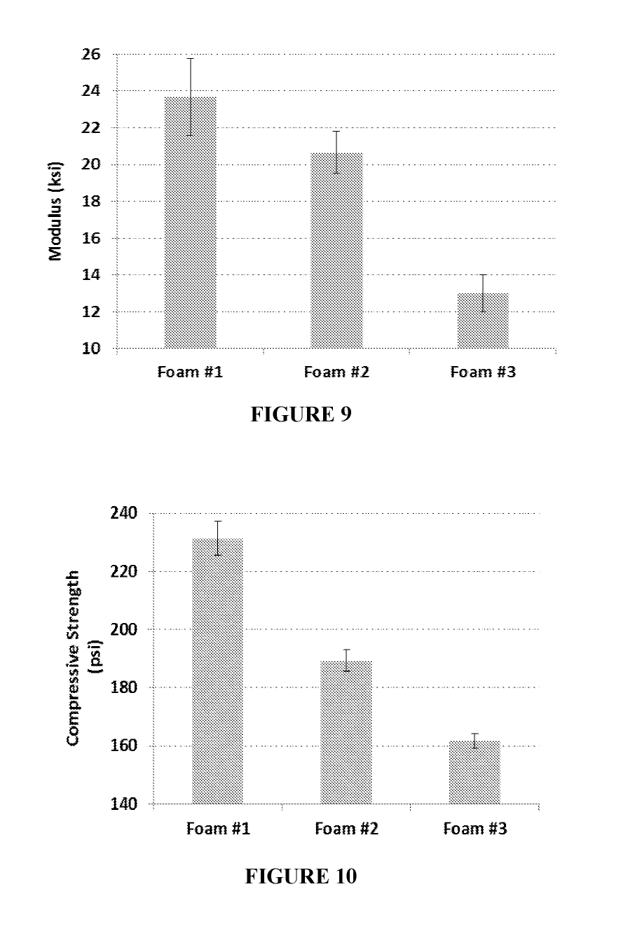

Flexural mechanical tests of flat samples were also conducted to measure the elastic modulus and compressive strength (maximum stress before the foam yielded) of the polyurethane foams 1-3. The modulus of elasticity was measured using the standard methods described in ASTM C947-03 (2009). The compressive strength was measured using the standard methods described in ASTM D1621 (2016). FIG. 9 is a histogram plotting the elastic modulus of foams 1-3. As shown in FIG. 9, the elastic modulus of foam 1 (23.7 ksi) is larger than the elastic modulus of foam 2 (20.7 ksi) or foam 3 (13.0 ksi). FIG. 10 is a histogram plotting the compressive strength of foams 1-3. As shown in FIG. 10, foam 1 also exhibits a much larger compressive strength (231.3 psi) than foam 2 (189.3 psi) or foam 3 (161.7 psi). These results demonstrate that foam 1 exhibits superior mechanical properties, including an improved elastic modulus and compressive strength, as compared to foam 2 and foam 3.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited.

Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

1. A filled polyurethane foam, the foam comprising from 50% to 90% by weight of an inorganic filler and an open cell structure having a mean trabecular separation of from 275 to 1,000 microns and a standard deviation of at least 30% of the mean trabecular separation;
wherein the foam has a surface to volume ratio of 90 or less.

2. The foam of claim 1, wherein the open cell structure has a mean trabecular separation of from 350 to 500 microns.

3. The foam of claim 1, wherein the standard deviation of the mean trabecular separation is from 30% to 55% of the mean trabecular separation.

4. The foam of claim 1, wherein the standard deviation of the mean trabecular separation is from 125 to 250 microns.

5. The foam of claim 1, wherein the surface to volume ratio is 85 or less.

6. The foam of claim 1, wherein the surface to volume ratio is from 60 to 80.

7. The foam of claim 1, wherein the open cell structure has an average trabecular thickness of at least 40 microns.

8. The foam of claim 1, wherein the open cell structure has an average trabecular thickness of from 40 to 55 microns.

9. A filled polyurethane foam, the foam comprising from 50% to 90% by weight of an inorganic filler and an open cell structure having a mean trabecular separation of from 50 to 1,000 microns and a standard deviation of at least 40% of the mean trabecular separation;
wherein the foam has a surface to volume ratio of 120 or less.

10-20. (canceled)

21. The foam of claim 1, wherein the foam exhibits a ratio of elastic modulus (in ksi) to density (in lb/ft³) of from 1:2 to 2:1.

22. The foam of claim 1, wherein the foam exhibits a compressive strength of 150 psi or greater.

23. The foam of claim 1, wherein the foam exhibits a compressive strength of 175 psi or greater.

24. The foam of claim 1, wherein the foam exhibits a compressive strength of 200 psi or greater.

25. The foam of claim 1, wherein the foam exhibits a compressive strength of 220 psi or greater.

26. The foam of claim 1, wherein the foam exhibits a compressive strength of from 200 to 250 psi.

27. The foam of claim 1, wherein the foam exhibits a compressive strength of from 220 to 240 psi.

28. The foam of claim 1, wherein the foam exhibits a ratio of compressive strength (in psi) to density (in lb/ft³) of from 8:1 to 25:1.

29. The foam of claim 1, wherein the foam exhibits a ratio of compressive strength (in psi) to density (in lb/ft³) of from 8:1 to 15:1.

30. The foam of claim 1, wherein the foam has a density of from 10 to 35 lb/ft³.

31-54. (canceled)

55. A method of making a filled polyurethane foam, comprising:
mixing one or more isocyanates selected from the group consisting of diisocyanates, polyisocyanates, and mixtures thereof, one or more polyols; and an inorganic filler to produce a mixture, wherein the inorganic filler is present in an amount from greater than 50% to 90% by weight, based on the total weight of the mixture, and wherein the mixture includes less than 0.1% by weight surfactant, based on the total weight of the mixture;
applying the mixture to a mold; and
allowing the mixture to react and expand to form the filled polyurethane foam comprising an open cell structure having a mean trabecular separation of from 50 to 1,000 microns and a standard deviation of at least 40% of the mean trabecular separation;
wherein the foam has a surface to volume ratio of 120 or less.

56-67. (canceled)
